(19) United States
(12) Patent Application Publication
(10) Pub. No.: US 2026/0238879 A1
(43) Pub. Date: Aug. 13, 2026

(54) DISPLAY CONTROL DEVICE, IMAGING APPARATUS, OPERATION METHOD AND OPERATION PROGRAM FOR DISPLAY CONTROL DEVICE

(71) Applicant: FUJIFILM Corporation, Tokyo (JP)

(72) Inventor: Ryosuke NAGAMI, Saitama-shi (JP)

(73) Assignee: FUJIFILM Corporation, Tokyo (JP)

(21) Appl. No.: 19/638,207

(22) Filed: Apr. 3, 2026

Related U.S. Application Data
(63) Continuation of application No. PCT/JP2024/032443, filed on Sep. 10, 2024.

(30) Foreign Application Priority Data
Oct. 4, 2023 (JP) 2023-173228

(51) Int. Cl. H04N 23/63

(52) U.S. Cl. CPC H04N 23/635; H04N 23/632

(57) ABSTRACT

A processor of a display control device acquires an image including a subject, detects, in addition to a subject region representing the subject, at least a part of the subject as a magnification target from the image, inserts, in a display screen on which the image is displayed, a magnification region obtained by magnifying a target region representing the magnification target into the display screen, and executes, in a case where an overlapping region in which the subject region and the magnification region overlap with each other is generated on the display screen and a condition is satisfied, overlapping degree reduction processing of reducing an overlapping degree of the overlapping region.

### CROSS-REFERENCE TO RELATED APPLICATIONS

This application is a continuation application of International Application No. PCT/JP 2024/032443, filed Sep. 10, 2024, the disclosure of which is incorporated herein by reference in its entirety. Further, this application claims priority from Japanese Patent Application No. 2023-173228, filed on Oct. 4, 2023, the disclosure of which is incorporated herein by reference in its entirety.

### BACKGROUND

### 1. Technical Field

The disclosed technology relates to a display control device, an imaging apparatus, an operation method and an operation program for a display control device.

### 2. Description of the Related Art

JP2010-226496A discloses an imaging apparatus comprising an imaging unit that generates first image data from an optical image of a subject in an imaging range, an auto-focus unit that automatically adjusts a focus position of the imaging unit to the subject, a focus region specifying unit that specifies a first region, which is a partial region in the first image data and includes the focus position, from the first image data, an image enlargement unit that enlarges second image data in the first image data corresponding to the first region, a composite region setting unit that sets a second region, in which the enlarged second image data is to be composited, to not overlap the focus position with respect to the first image data, an image synthesizing unit that synthesizes the enlarged second image data into the second region in the first image data, and an image output unit that outputs the first image data in which the enlarged second image data is composited.

JP2009-089051A discloses an imaging apparatus comprising an imaging unit that images a subject to generate image data, a recording unit that records the image data generated by the imaging unit, a display unit that displays an image based on the image data generated by the imaging unit on a main screen and displays an image based on the image data recorded by the recording unit on a sub screen, a face detection unit that detects a face image based on the image data generated by the imaging unit, an overlap determination unit that determines whether or not a detection region of the detected face image and a region of the sub screen overlap each other in a case where the face image is detected by the face detection unit, and a display control unit that controls display of the main screen or the sub screen such that the face image is visible in a case where the overlap determination unit determines that the detection region of the face image and the region of the sub screen overlap each other.

### SUMMARY OF THE INVENTION

One embodiment according to the disclosed technology provides a display control device, an imaging apparatus, an operation method and an operation program for a display control device that make it easier to check a composition and check a focusing state than in the related art.

In order to achieve the above object, a display control device according to the disclosed technology comprises a processor, in which the processor acquires an image including a subject, detects, in addition to a subject region representing the subject, at least a part of the subject as a magnification target from the image, inserts, in a display screen on which the image is displayed, a magnification region in which a target region representing the magnification target is magnified, into the display screen, and executes, in a case where an overlapping region in which the subject region and the magnification region overlap with each other is generated on the display screen and a condition is satisfied, overlapping degree reduction processing of reducing an overlapping degree of the overlapping region.

Preferably, the processor executes the overlapping degree reduction processing by adjusting at least one of a display size or an insertion position of the magnification region.

Preferably, in the overlapping region, the magnification region is displayed in front of the subject region.

Preferably, the condition is defined by a magnitude relationship between a numerical indicator indicating the overlapping degree and a threshold value.

Preferably, the numerical indicator includes any one of a ratio of an area of the overlapping region to an area of the subject region or an area of the magnification region, the number of the overlapping regions, or a distance between the subject region and the magnification region.

Preferably, the threshold value is changeable according to a portion of the subject in the overlapping region.

Preferably, the numerical indicator is a ratio of an area of the overlapping region to an area of the subject region or an area of the magnification region, and the threshold value is changeable according to the area of the subject region.

Preferably, in a case where the subject region is detected as a rectangular region including the subject, the processor determines at least one of presence or absence of the overlapping region or whether or not the condition is satisfied, based on the overlap between the rectangular region and the magnification region.

Preferably, the target region is also detected as a rectangular region including the magnification target.

Preferably, in a case where a plurality of the subjects are included in the image and at least one magnification target among the plurality of subjects is inserted as the magnification region, the processor determines presence or absence of the overlapping region based on a relationship between the magnification region and a subject region corresponding to the magnification region.

Preferably, in a case where a first subject and a second subject are included in the image as the subjects, and a first magnification region that is the magnification region corresponding to the magnification target of the first subject and a second magnification region that is the magnification region corresponding to the magnification target of the second subject are inserted, the processor determines a positional relationship between the first magnification region and the second magnification region based on a positional relationship between a first subject region representing the first subject and a second subject region representing the second subject in the image.

Preferably, in a case where a plurality of initial positions are set as insertion positions of the magnification region with priorities assigned, the processor determines the insertion position according to the priority in a case where each of the plurality of initial positions satisfies the condition.

Preferably, in a case where the subject is a biological body, a portion detected as the magnification target is any one of an eye, a face, or a head of the subject.

Preferably, a determination cycle of whether or not to execute the overlapping degree reduction processing corresponds to any one of a refresh rate of the display screen or a frame rate of the image.

Preferably, the processor does not execute the overlapping degree reduction processing in a case where a movement amount and a reduction rate of the magnification region determined in the overlapping degree reduction processing are equal to or less than preset set values, even in a case where the condition is satisfied.

Preferably, in a case where the detection of the magnification target from the image is repeatedly performed, the processor executes at least one of determination of the magnification target or determination of content of the overlapping degree reduction processing based on a past detection result in a case where an indicator related to accuracy of the detection of the magnification target is equal to or less than a preset reference.

Preferably, the overlapping degree reduction processing includes processing of adjusting a transparency of the overlapping region.

Preferably, the processor determines a portion of the subject as the magnification target according to a size of the subject in the image.

Preferably, the processor adjusts visibility of the magnification region separately from the subject region.

An imaging apparatus according to the disclosed technology is an imaging apparatus comprising the display control device according to any one of the above, the processor starts display of the magnification region in a case where an imaging operation is started.

Preferably, the imaging operation is a focusing operation.

Preferably, the processor ends the display of the magnification region in a case where the imaging operation ends.

Preferably, the processor starts or ends the display of the magnification region based on an operation of a release button.

An operation method of a display control device according to the disclosed technology is an operation method of a display control device including a processor, comprising: via the processor acquiring an image including a subject; detecting, in addition to a subject region representing the subject, at least a part of the subject as a magnification target from the image; inserting, in a display screen on which the image is displayed, a magnification region in which a target region representing the magnification target is magnified, into the display screen; and executing, in a case where an overlapping region in which the subject region and the magnification region overlap with each other is generated on the display screen and a condition is satisfied, overlapping degree reduction processing of reducing an overlapping degree of the overlapping region.

An operation program of a display control device according to the disclosed technology is an operation program of a display control device including a processor, the operation program causing the processor to execute a process of: acquiring an image including a subject; detecting, in addition to a subject region representing the subject, at least a part of the subject as a magnification target from the image; inserting, in a display screen on which the image is displayed, a magnification region obtained by magnifying a target region representing the magnification target into the display screen; and executing, in a case where an overlapping region in which the subject region and the magnification region overlap with each other is generated on the display screen and a condition is satisfied, overlapping degree reduction processing of reducing an overlapping degree of the overlapping region.

According to the disclosed technology, it is easy to check both the composition and the focusing state as compared with the related art.

### BRIEF DESCRIPTION OF THE DRAWINGS

FIG. 1 is a diagram showing an appearance of an imaging apparatus.

FIG. 2 is a diagram showing an example of a configuration of an imaging apparatus.

FIG. 3 is a block diagram showing an example of a functional configuration of a processor.

FIG. 4 is a diagram showing an example of detecting eyes as subject detection.

FIG. 5 is a diagram showing an example of detecting a face as subject detection.

FIG. 6 is a diagram showing an example of detecting a head as subject detection.

FIG. 7 is a diagram showing an example of PIP display.

FIG. 8 is a diagram showing an example of overlapping degree reduction processing.

FIG. 9 is a diagram showing another example of the overlapping degree reduction processing.

FIG. 10 is a diagram showing an example of control information related to the overlapping degree reduction.

FIG. 11 is a flowchart showing an example of a processing procedure of the PIP display during a focusing operation.

FIG. 12 is a diagram showing an example of control information of Modification Example 1.

FIG. 13 is a diagram showing an example of a display state in which a threshold value is changed according to a portion of Modification Example 1.

FIG. 14 is a flowchart showing a processing procedure of Modification Example 1.

FIG. 15 is a diagram showing an example of control information of Modification Example 2.

FIG. 16 is a diagram showing an example of a display state in which a threshold value is changed according to an area of a subject region of Modification Example 2.

FIG. 17 is a diagram showing another example of the control information of Modification Example 2.

FIG. 18 is a diagram showing various indicators of the overlapping degree.

FIG. 19 is a diagram showing an example in which the number of overlapping regions is used as an indicator of the overlapping degree.

FIG. 20 is a diagram showing an example in which a distance between the subject region and the magnification region is used as an indicator of the overlapping degree.

FIG. 21 is a diagram showing an example of a calculation method of the overlapping region.

FIG. 22 is a diagram showing an example in which an initial position of an insertion position of the magnification region is determined by a priority.

FIG. 23 is a diagram showing an example of a determination method of the overlapping region in a case where there are a plurality of subjects.

FIG. 24 is a diagram showing an example in which a positional relationship between a plurality of subjects and a plurality of magnification regions is associated with each other.

FIG. 25 is a diagram showing an example of a hunting countermeasure using a dead zone.

FIG. 26 is a diagram showing an example of a hunting countermeasure caused by detection accuracy.

FIG. 27 is a diagram showing an example in which a part to be magnified is determined according to a size of the subject.

FIG. 28 is a diagram showing an example in which visibility of the magnification region is improved.

FIG. 29 is a diagram showing an example in which transparency of the overlapping region is adjusted as the overlapping degree reduction processing.

### DETAILED DESCRIPTION

An example of embodiments of the technology of the present disclosure will be described with reference to the accompanying drawings.

First, the terms used hereinafter will be described.

In the following description, the “IC” is an abbreviation for “integrated circuit”. “CPU” is an abbreviation for “central processing unit”. “ROM” is an abbreviation for “read-only memory”. “RAM” is an abbreviation for “random access memory”. “CMOS” is an abbreviation for “complementary metal-oxide-semiconductor”. “FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”. “AF” is an abbreviation of “auto focus”. “PIP” is an abbreviation for “picture-in-picture”.

As an embodiment of an imaging apparatus, the technique of the present disclosure will be described by using a lens-interchangeable digital camera as an example. The technology of the present disclosure is not limited to the lens-interchangeable type, and can be applied to a lens-integrated digital camera. The disclosed technology can also be applied to a digital camera built in a smart device or the like.

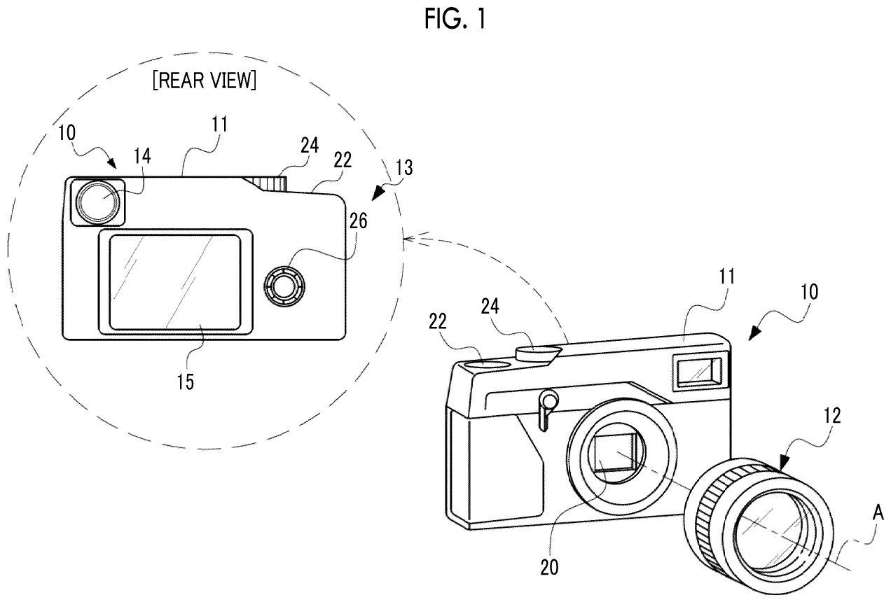

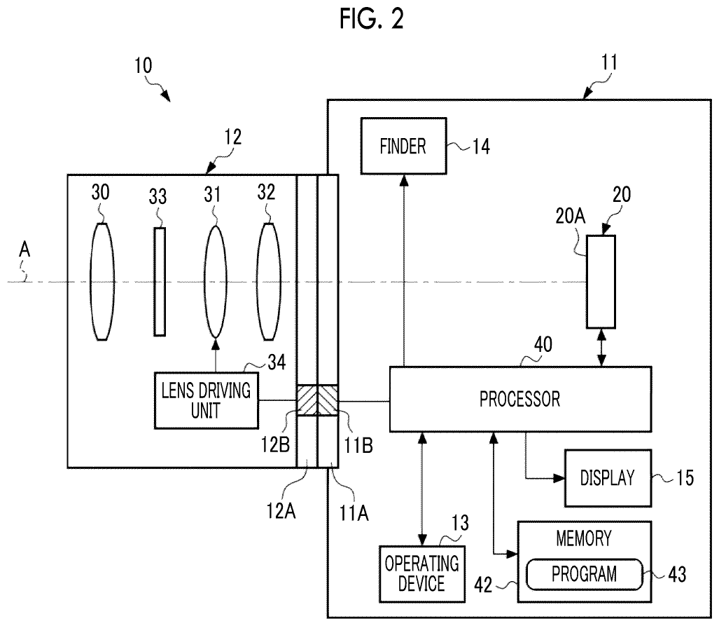

FIG. 1 is an external view of an imaging apparatus 10, and FIG. 2 illustrates an example of an internal configuration of the imaging apparatus 10. As illustrated in FIGS. 1 and 2, the imaging apparatus 10 is a lens-interchangeable digital camera. The imaging apparatus 10 includes a main body 11 and an imaging lens 12 which is interchangeably mounted on the main body 11. The imaging lens 12 is attached to a front surface side of the main body 11 via a camera-side mount 11A and a lens-side mount 12A.

The main body 11 is provided with an operation unit such as a dial 24, a release button 22, and a display 15 with a touch panel function. These operation units constitute an operation device 13 that receives an operation by a user. Examples of the operation mode of the imaging apparatus 10 include a still image capturing mode, a video image capturing mode, and an image display mode. Further, the still image capturing mode includes a continuous imaging mode. For example, the dial 24 is operated by the user in a case of setting the operation mode. The release button 22 is operated by a user to start executing still image capturing or video image capturing. In addition, the display 15 with a touch panel function is used for displaying various setting screens in addition to reproducing and displaying the captured image. Further, the display 15 with a touch panel function is operated by the user in a case of designating an AF area to be a focus target from within an imaging region.

In addition, the main body 11 is provided with the finder 14. Here, the finder 14 is a hybrid finder (registered trademark). The hybrid finder refers to, for example, a finder in which an optical viewfinder (hereinafter, referred to as “OVF”) and an electronic viewfinder (hereinafter, referred to as “EVF”) are selectively used. The user can observe an optical image or a live view image of the subject projected onto the finder 14 via a finder eyepiece portion (not shown).

In addition, the display 15 is provided on a rear surface side of the main body 11. The user can also observe the live view image projected onto the display 15 instead of the finder 14.

The main body 11 and the imaging lens 12 are electrically connected to each other by bringing an electrical contact 11B provided on a camera-side mount 11A into contact with an electrical contact 12B provided on a lens-side mount 12A.

The imaging lens 12 includes an objective lens 30, a focus lens 31, a rear-end lens 32, and a stop 33. Respective members are arranged in the order of the objective lens 30, the stop 33, the focus lens 31, and the rear-end lens 32 from an objective side along an optical axis A of the imaging lens 12. The objective lens 30, the focus lens 31, and the rear-end lens 32 constitute an imaging optical system. Types, numbers, and arrangement orders of lenses constituting the imaging optical system are not limited to the example illustrated in FIG. 2.

In addition, the imaging lens 12 includes a lens driving unit 34. The lens driving unit 34 includes, for example, a CPU, a RAM, a ROM, and the like. The lens driving unit 34 is electrically connected to a processor 40 inside the main body 11 via the electrical contact 12B and the electrical contact 11B.

The lens driving unit 34 drives the focus lens 31 and the stop 33 based on a control signal transmitted from the processor 40. The lens driving unit 34 performs drive control of the focus lens 31 based on a control signal for focusing control transmitted from the processor 40 in order to adjust a focus position FP of the imaging lens 12. The processor 40 performs, for example, a phase-difference-type focus position detection.

The stop 33 has an opening whose opening diameter is variable with the optical axis A as the center. The lens driving unit 34 performs drive control of the stop 33 based on a control signal for stop adjustment that is transmitted from the processor 40, in order to adjust an amount of light incident on a light-receiving surface 20A of an imaging sensor 20.

Moreover, the imaging sensor 20, the processor 40, and a memory 42 are provided inside the main body 11. The operations of the imaging sensor 20, the memory 42, the operation device 13, the finder 14, and the display 15 are controlled by the processor 40.

The processor 40 is configured by, for example, a CPU. In this case, the processor 40 executes various types of processing based on a program 43 stored in the memory 42. The processor 40 may include an assembly of a plurality of IC chips. The memory 42 is configured by, for example, at least one of various storages such as a RAM, a flash memory, and a hard disk drive. In addition, the memory 42 may include a ROM.

The imaging sensor 20 is, for example, a CMOS type image sensor. The imaging sensor 20 is disposed such that the optical axis A is orthogonal to the light-receiving surface 20A and the optical axis A is located at the center of the light-receiving surface 20A. Light that has passed through the imaging lens 12 is incident on the light-receiving surface 20A. A plurality of pixels for generating signals through photoelectric conversion are formed on the light-receiving surface 20A. The imaging sensor 20 generates and outputs an image signal D by photoelectrically converting the light incident on each pixel. The imaging sensor 20 is an example of “imaging element” according to the technique of the present disclosure.

In addition, for example, a color filter array of a Bayer array is disposed on the light-receiving surface 20A of the imaging sensor 20, and a color filter of any one of red (R), green (G), or blue (B) is disposed to face each pixel.

As an example, a phase difference method is adopted as a focusing method of the imaging apparatus 10. As is well known, the phase difference method is a method using a pair of phase-difference detection pixels that are arranged with parallax and through which different incident luminous fluxes are incident by pupil splitting. In the phase difference method, a deviation amount of the focus lens 31 from a focus position is detected as a phase difference by the pair of phase-difference detection pixels, and the focus lens 31 is moved to the focus position based on the detected phase difference. The imaging apparatus 10 adopts an image plane phase difference method, and the phase-difference detection pixels are provided in at least some of a plurality of pixels arranged on the light-receiving surface 20A of the imaging sensor 20. A plurality of pairs of phase-difference detection pixels are dispersedly disposed in the light-receiving surface 20A, and in the imaging apparatus 10, it is possible to set an AF area over the entire imaging range imaged by the light-receiving surface 20A. As the focusing method, a contrast detection method of searching for the focus position based on a signal output by the imaging sensor 20 while moving the focus lens 31 may be adopted instead of the phase difference method.

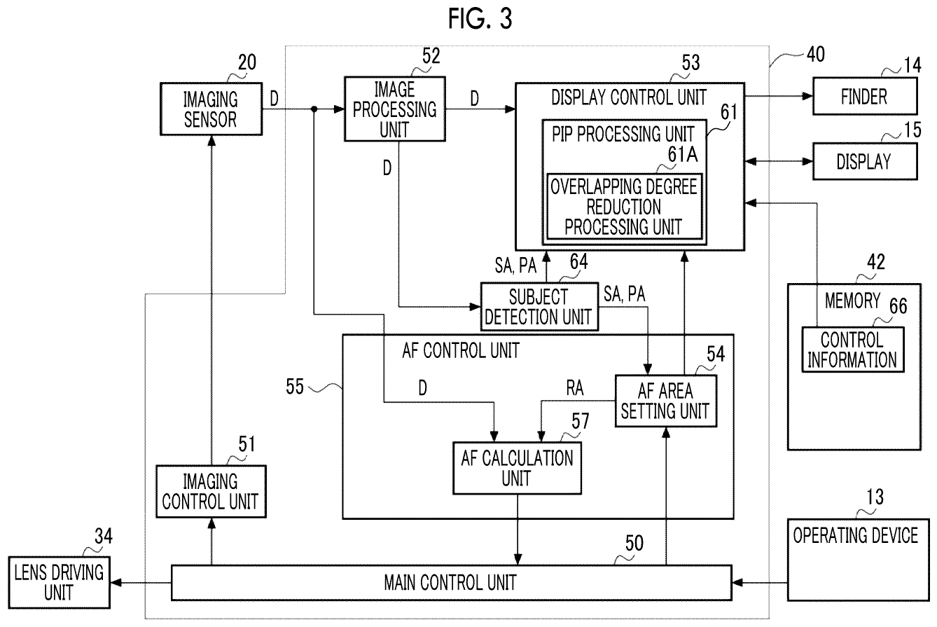

FIG. 3 shows an example of a functional configuration of the processor 40. The processor 40 executes processing in accordance with the program 43 stored in the memory 42, to implement various functional units. As shown in FIG. 3, for example, a main control unit 50, an imaging control unit 51, an image processing unit 52, a display control unit 53, an AF control unit 55, and a subject detection unit 64 are implemented in the processor 40. The program 43 is an example of an “operation program” according to the disclosed technology.

The main control unit 50 comprehensively controls the operation of the imaging apparatus 10 based on output information from the operation device 13. The imaging control unit 51 executes imaging processing of causing the imaging sensor 20 to perform an imaging operation by controlling the imaging sensor 20. The imaging control unit 51 drives the imaging sensor 20 in the still image capturing mode or the video image capturing mode.

The imaging sensor 20 outputs an image signal D including an imaging signal and a signal from a phase-difference detection pixel.

The image processing unit 52 acquires the image signal D output from the imaging sensor 20, and performs image processing such as demosaicing on the acquired image signal D.

The AF control unit 55 performs focusing control by adjusting the focus lens 31 to the focus position FP. The AF control unit 55 is composed of an AF area setting unit 54 and an AF calculation unit 57.

The AF area setting unit 54 sets an AF area RA (see FIG. 7 and the like) that is a region to be focused on in the imaging region 20B. For example, as shown in FIG. 7, the AF area setting unit 54 sets a region including at least a part of the subject detected by the subject detection unit 64 as the AF area RA. FIG. 7 shows an example in which the subject is a person, the eye is detected as the focusing target, and a region including the detected eye is set as the AF area RA.

Returning to FIG. 3, the subject detection unit 64 recognizes the subject by using an image recognition technology based on a pattern matching method or an artificial intelligence (AI) method based on the image signal D. The subject to be recognized is at least a part of the subject, that is, both the entire subject and a part of the subject. Examples of the subject include a person, an animal, and a vehicle. In a case where the subject is a person, an animal, or the like, the part of the subject is an eye, a face, a head, or the like. Examples of the vehicle include an automobile, a train, and an airplane. In a case where the subject is a vehicle, the part of the subject is a leading portion, a window, a rear portion, or the like.

For example, the subject detection unit 64 can continuously perform the detection of the subject and the part of the subject in a case where the user performs framing for checking the composition while half-pressing the release button 22 or in a case where the user performs continuous shooting for continuously capturing a plurality of images while fully pressing the release button 22. Thereby, even in a case where the subject moves, it is possible to track the AF area RA. The subject detection unit 64 continuously outputs information of the AF area RA that moves according to the movement of the subject, to the AF area setting unit 54.

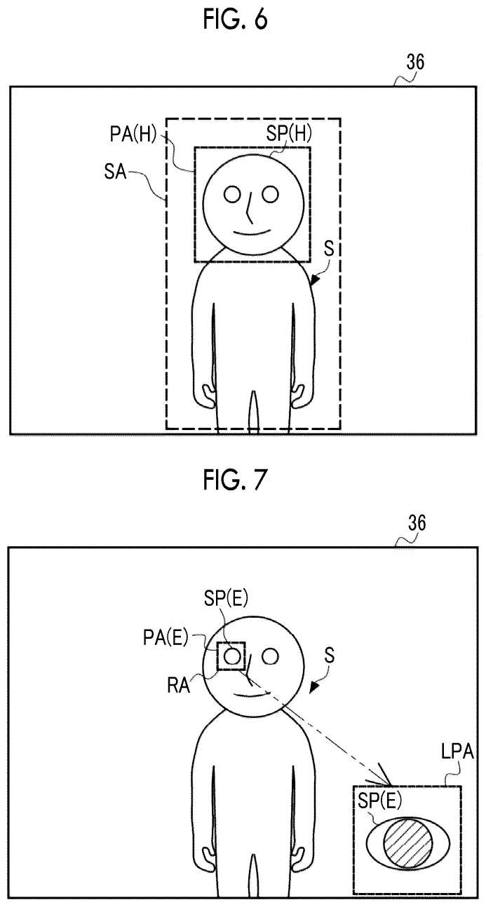

The subject detection unit 64 detects a region representing the entire subject as a subject region SA (for example, see FIG. 6) and a region representing a part of the subject as a target region PA (for example, see FIG. 6). The target region PA is a region set as a focus target and is also a region including a magnification target SP to be enlarged in PIP display described later. The subject detection unit 64 outputs information on the subject region SA and the target region PA to the display control unit 53 and the AF area setting unit 54.

In addition, the AF area setting unit 54 can also set, as the AF area RA, a region designated by the user via the operation device 13. For example, the AF area RA can be designated by touching the touch panel of the display 15 as the operation device 13 with a finger.

The AF calculation unit 57 acquires information on the AF area RA from the AF area setting unit 54 and calculates a defocus amount in the AF area RA based on a signal of a phase-difference detection pixel in the image signal D. The defocus amount represents an amount of shift from a focus position of the focus lens 31, and the main control unit 50 adjusts the focus position by driving the focus lens 31 via the lens driving unit 34 based on the defocus amount. Thereby, the subject in the AF area RA is in a focused state.

The display control unit 53 displays an image represented by the image signal D subjected to the image processing by the image processing unit 52 on the finder 14 or the like. In addition, the display control unit 53 displays a live view image on the finder 14 or the like based on the image signal D periodically input from the image processing unit 52 during an imaging preparation operation before still image capturing or video image capturing.

The imaging apparatus 10 has a PIP function of enlarging a target region PA set as the AF area RA and inserting an enlarged magnification region LPA (refer to FIG. 7 and the like) into a display screen as a sub screen in a case where performing live view display, in which a live view image is displayed on the display screen such as the finder 14. The display control unit 53 includes a PIP processing unit 61 that performs PIP processing.

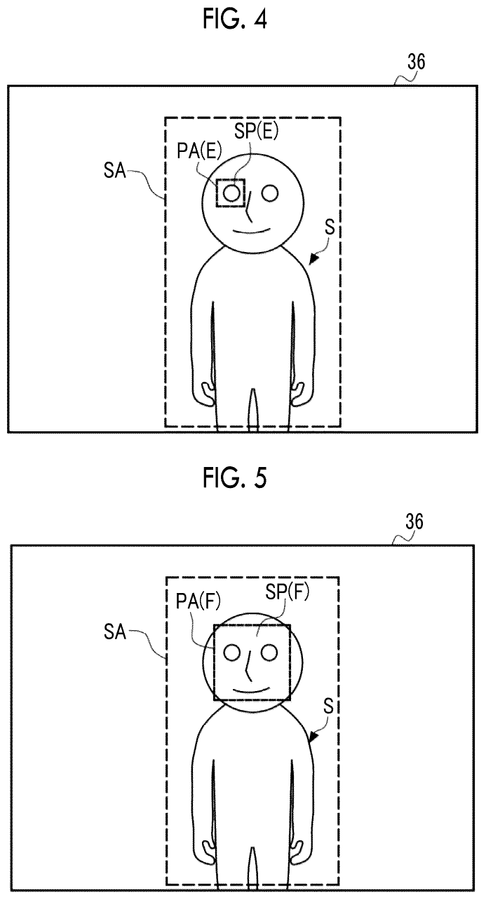

A specific example of subject detection that is a premise of the PIP processing will be described with reference to FIGS. 4 to 6. FIGS. 4 to 6 are all examples in which the subject is a person. The examples of FIGS. 4 to 6 are examples in which a subject S of a person and a part of the subject S are detected as a magnification target SP. FIG. 4 is an example in which an eye SP(E) is detected as the magnification target SP. The subject detection unit 64 detects the subject S and the eye SP(E) from an image 36 represented by the image signal D through image recognition processing and detects a subject region SA representing the subject S and a target region PA(E) representing the eye SP(E). The subject region SA and the target region PA(E) are detected as rectangular regions including the subject S or the eye SP(E), respectively.

FIG. 5 is an example in which a face SP(F) is detected as the magnification target SP. The subject detection unit 64 detects the subject S and the face SP(F) from the image 36 represented by the image signal D through image recognition processing and detects the subject region SA representing the subject S and the target region PA(F) representing the face SP(F). The subject region SA and the target region PA(F) are detected as rectangular regions including the subject S or the face SP(F), respectively.

Similarly, FIG. 6 is an example in which a head SP(H) is detected as the magnification target SP. The subject detection unit 64 detects the subject S and the head SP(H) from the image 36 represented by the image signal D through image recognition processing and detects the subject region SA representing the subject S and the target region PA(H) representing the head SP(H). The subject region SA and the target region PA(H) are detected as rectangular regions including the subject S or the head SP(H), respectively.

The target region PA is a region set as the AF area RA. Then, the PIP processing unit 61 performs image composition of enlarging the target region PA in the PIP processing and inserting the enlarged magnified image as a sub screen in the display screen on which the entire image 36 is displayed.

FIG. 7 is an example of the PIP display by the PIP processing. In the example shown in FIG. 7, in the display screen on which the image 36 including the subject S is displayed, an magnification region LPA, which is a magnified image obtained by enlarging the target region PA(E) representing the eye SP(E) of the subject S, is inserted as the sub screen. By performing the PIP display of inserting the magnification region LPA in the image 36 in this way, it is possible to check the composition, such as where and to what extent the subject S is disposed in the entire image 36, and to check the focusing state of whether or not the subject S is in focus by the magnification region LPA of the eye SP(E).

An initial position of the insertion position of the magnification region LPA is set, for example, to a lower right corner or a lower left corner of the display screen. In a case where the PIP display is performed, in a case where the insertion position of the magnification region LPA is fixed, the magnification region LPA and the subject region SA may overlap each other.

Returning to FIG. 3, the PIP processing unit 61 is provided with an overlapping degree reduction processing unit 61A. The overlapping degree reduction processing unit 61A executes overlapping degree reduction processing of reducing an overlapping degree in a case where the magnification region LPA and the subject region SA overlap each other. The memory 42 stores control information 66. The control information 66 is information that defines a rule of processing in a case where the overlapping degree reduction processing is executed.

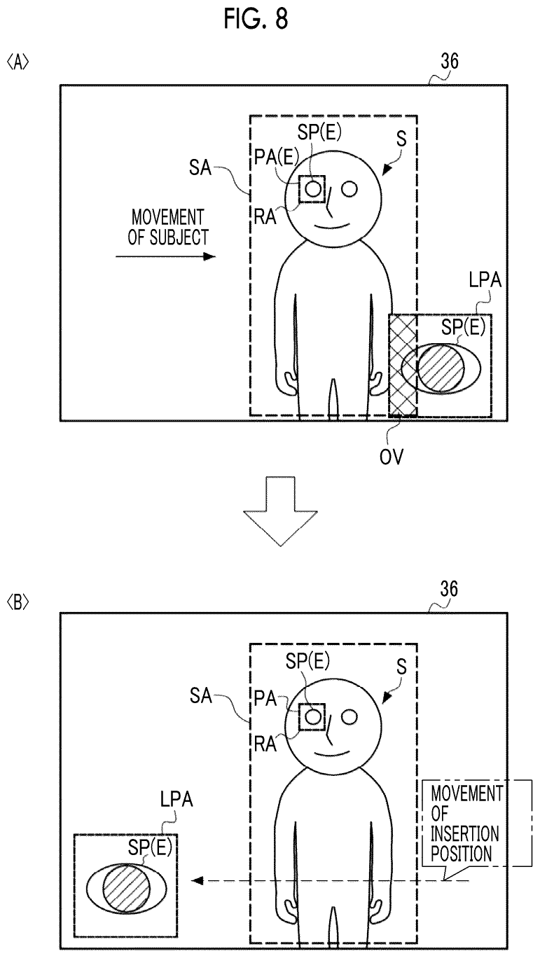

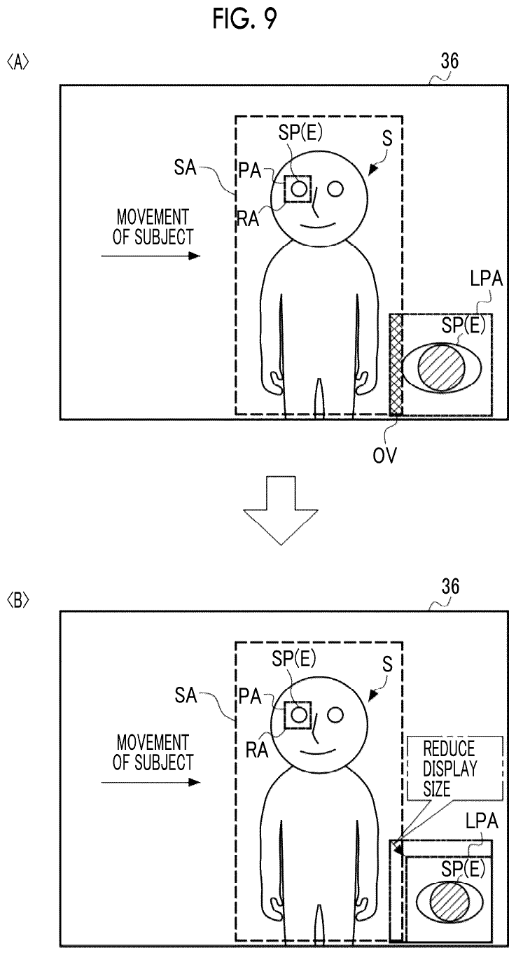

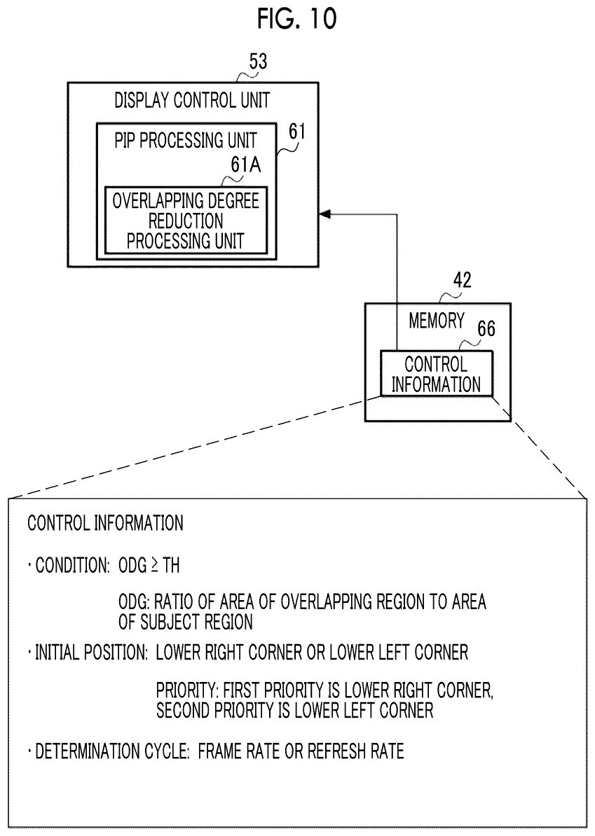

FIGS. 8 and 9 show an example of the overlapping degree reduction processing. FIGS. 8 and 9 show an example in which the subject region SA and the magnification region LPA overlap each other due to the movement of the subject S as shown in the diagrams of <A> in the upper parts of FIGS. 8 and 9. In a case where the overlapping region OV in which the subject region SA and the magnification region LPA overlap each other is generated on the display screen of the image 36 and a condition set in advance is satisfied, the overlapping degree reduction processing unit 61A executes overlapping degree reduction processing of reducing an overlapping degree ODG (refer to FIG. 10) of the overlapping region OV. The condition set in advance is an example of a “condition” according to the disclosed technology.

The overlapping degree reduction processing unit 61A calculates the presence or absence of the overlapping region OV and an area of the overlapping region OV based on the coordinate information of each of the subject region SA and the magnification region LPA.

Since the magnification region LPA is a region for checking the in-focus state, in the present example, the magnification region LPA is displayed in front of the subject region SA in the overlapping region OV.

As shown in FIG. 8 as an example of the overlapping degree reduction processing, the overlapping degree reduction processing unit 61A executes processing of adjusting an insertion position of the magnification region LPA. FIG. 8 shows an example in which the insertion position of the magnification region LPA inserted into the lower right corner is changed to the lower left corner with reference to the side on which the image 36 is visually recognized. The overlapping degree reduction processing unit 61A searches for a position at which the subject region SA and the magnification region LPA do not overlap or overlap to a small extent based on the position of the subject region SA in the image 36, and determines the searched position as the insertion position. Then, the magnification region LPA is moved to the determined insertion position.

Further, as shown in FIG. 9 as an example of the overlapping degree reduction processing, the overlapping degree reduction processing unit 61A executes processing of adjusting a display size of the magnification region LPA. FIG. 9 shows an example in which the display size of the magnification region LPA is reduced. The overlapping degree reduction processing unit 61A calculates an area of a region near the current insertion position of the magnification region LPA based on the position of the subject region SA in the image 36, and determines a reduction rate of the magnification region LPA that does not overlap with the subject region SA. Then, the magnification region LPA is reduced at the determined reduction rate.

In the examples shown in FIGS. 8 and 9, the overlapping is completely eliminated by the overlapping degree reduction processing, and the overlapping region OV is eliminated. However, in practice, the overlapping may not be completely eliminated, and the overlapping region OV may remain. In the overlapping degree reduction processing, it is sufficient that an overlapping degree ODG is reduced by comparing a state before the processing with a state after the processing, and a part of the overlapping region OV may remain. The overlapping degree ODG is an indicator indicating a degree of overlap between the subject region SA and the magnification region LPA. The indicator is, for example, a numerical indicator such as a proportion of an area of the overlapping region OV to an area of the subject region SA. The area is calculated using the number of pixels, coordinate information defining a pixel position of the image 36, and the like. In a case where the subject region SA and the magnification region LPA are detected as rectangular regions, as shown in FIGS. 8 and 9 as an example, a region in which the rectangular regions overlap with each other is the overlapping region OV.

As shown in FIG. 10, the control information 66 includes information such as a condition for determining whether or not to execute the overlapping degree reduction processing, an initial position of the magnification region LPA, and a determination cycle. In the example shown in FIG. 10, the condition is, for example, a condition in which the overlapping degree ODG is equal to or greater than a threshold value TH set in advance (ODG≥TH). In the example of FIG. 10, the overlapping degree ODG is defined as a proportion of the area of the overlapping region OV to the area of the subject region SA. As described above, the condition is defined by a magnitude relationship between a numerical indicator indicating an overlapping degree of the overlapping region OV, such as the overlapping degree ODG, and the threshold value TH, as an example.

In addition, as the initial position, a lower left corner or a lower right corner of the display screen is set. Further, in the example shown in FIG. 10, a priority is set for the initial position, and the first priority is the lower right corner and the second priority is the lower left corner. For example, in a case where the insertion position of the magnification region LPA is the lower right corner with the first priority and the overlapping with the subject region SA occurs, the lower left corner with the second priority is selected. In addition, the determination cycle is a determination cycle for determining whether or not to execute the overlapping degree reduction processing, and is more specifically a cycle for determining whether or not the condition is satisfied. In the example shown in FIG. 10, the determination cycle is defined as a frame rate, which is an imaging period of the imaging sensor 20, or a refresh rate, which is an update cycle of the display screen of the display 15. Any one of the frame rate or the refresh rate can be selected as the determination cycle by the setting of the user. The device composed of the processor 40 including the display control unit 53 and the memory 42 is an example of a “display control device” according to the disclosed technology, and the imaging apparatus 10 is an example of an “imaging apparatus” according to the disclosed technology.

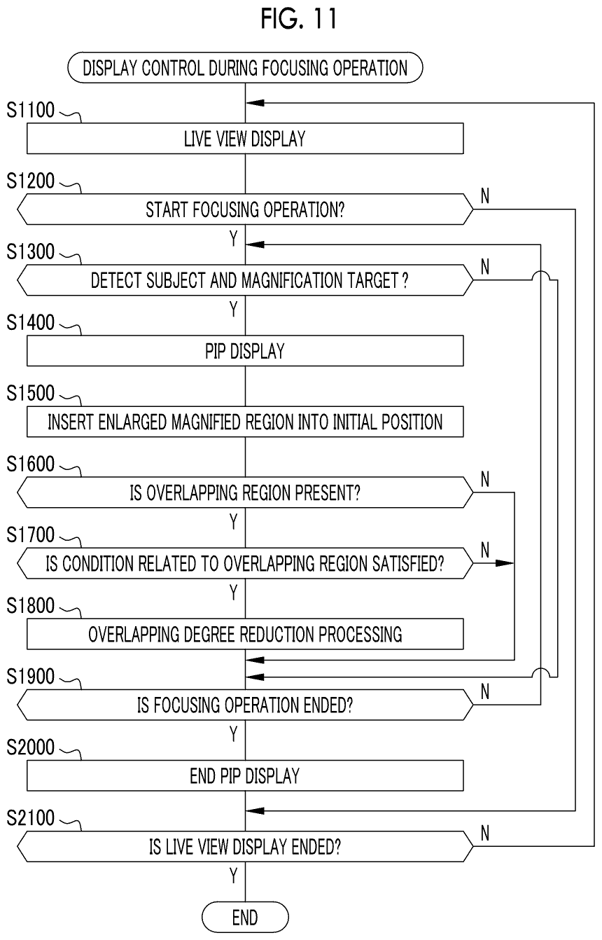

Hereinafter, an operation of the above-mentioned configuration will be described with reference to a flowchart shown in FIG. 11. The flowchart shown in FIG. 11 shows an operation procedure of the display control during the focusing operation of the imaging apparatus 10. For example, in a case where the still image capturing mode is selected as the operation mode, the display control unit 53 starts the live view display on the finder 14 in step S1100. The user can check the composition by the live view display.

In step S1200, the display control unit 53 waits for an instruction to start the focusing operation. In a case where the focusing operation is instructed by the half push of the release button 22 (Y in step S1200), the subject detection unit 64 detects the subject S and the magnification target SP from the image 36. As shown in FIG. 7, in a case where the subject S is a person, the magnification target SP is, for example, an eye SP(E) of the subject S. In step S1300, in a case where the subject S and the magnification target SP are detected (Y in step S1300), the processing proceeds to step S1400, and the PIP processing unit 61 starts the PIP display in the display control unit 53.

On the other hand, the AF control unit 55 sets the target region PA including the magnification target SP as the AF area RA and performs the focusing operation.

In step S1500, the PIP processing unit 61 enlarges the target region PA representing the detected magnification target SP and inserts the enlarged magnification region LPA into the initial position of the display screen on which the image 36 is displayed. Accordingly, as shown in FIG. 7, the magnification region LPA is displayed, and thus the user can check whether or not the subject S is in focus while observing the magnification region LPA, that is, can check the focusing state of the subject S.

In step S1600, the PIP processing unit 61 monitors whether or not the overlapping region OV in which the subject region SA and the magnification region LPA overlap each other is generated on the display screen.

In step S1600, in a case where it is determined that the overlapping region OV is present (Y in step S1600), the PIP processing unit 61 determines whether or not a condition related to the overlapping region OV shown in the control information 66 of FIG. 10 is satisfied.

In a case where the condition is satisfied (Y in step S1700), the processing proceeds to step S1800, and the overlapping degree reduction processing unit 61A of the PIP processing unit 61 executes the overlapping degree reduction processing of adjusting the insertion position or the display size of the magnification region LPA as shown in FIGS. 8 and 9. Accordingly, the overlapping degree ODG between the subject region SA and the magnification region LPA is reduced. Therefore, the imaging apparatus 10 can easily check the composition and check the focusing state as compared with a case where the overlapping degree reduction processing is not performed.

In step S1900, the PIP processing unit 61 waits for the end of the focusing operation. The focusing operation ends, for example, in a case where the release button 22 in the half push state is fully pushed or the half push is stopped. In a case where the focusing operation is continued (N in step S1900), the PIP processing unit 61 repeats the processing of step S1300 to step S1800. The subject S and the magnification target SP are detected in step S1300, but the detection is performed in accordance with the frame rate of the imaging sensor 20, that is, each time the live view image is acquired. The PIP display in step S1400 is updated each time the subject S and the magnification target SP are detected.

On the other hand, in a case where the focusing operation ends in step S1900 (Y in step S1900), the processing proceeds to step S2000, and the PIP processing unit 61 ends the PIP display. In a case where the PIP display ends, the display control unit 53 proceeds to step S2100 and repeats the above-described processing until the live view display ends.

As described above, in the disclosed technology, in addition to the subject region SA representing the subject S, at least a part of the subject S is detected as the magnification target SP from the image 36, and the magnification region LPA in which the target region PA representing the magnification target SP is magnified is inserted into the display screen on which the image 36 is displayed. In a case where the overlapping region OV in which the subject region SA and the magnification region LPA overlap is generated on the display screen and a condition defined by a relationship between the overlapping degree ODG and the threshold value TH is satisfied, the overlapping degree reduction processing of reducing the overlapping degree ODG of the overlapping region OV is executed. Therefore, according to the disclosed technology, it is easy to check the composition and check the focusing state as compared with the related art.

In addition, since the processor 40 executes the overlapping degree reduction processing by adjusting at least one of the display size of the magnification region LPA or the insertion position, the processing may be simpler than in other methods.

In addition, since the magnification region LPA is displayed on the front surface in the overlapping region OV as compared with the subject region SA, it is easy to check the focusing state as compared with a case where the subject region SA is displayed on the front surface.

In addition, since the condition for determining whether or not to execute the overlapping degree reduction processing is defined by a magnitude relationship between the numerical indicator indicating the overlapping degree ODG and the threshold value TH, the processing may be simpler than in a case where the numerical indicator is not used.

In addition, since the numerical indicator is a proportion of the area of the overlapping region OV to the area of the subject region SA, the numerical indicator is also easy to understand intuitively.

In addition, in a case where the subject region SA is detected as the rectangular region including the subject S, the processor 40 determines at least one of the presence or absence of the overlapping region OV or whether or not a condition (an example of a first condition) for determining whether or not to execute the overlapping degree reduction processing is satisfied, based on the overlap between the rectangular region and the magnification region LPA. In a case where the determination is not made in the rectangular region, the complexity of the processing is suppressed as compared with, for example, a case where the contour of the subject S is extracted and a region within the extracted contour is used. Further, since the target region PA is also detected as the rectangular region including the target region PA, the complexity of the processing is suppressed for the same reason.

In addition, in a case where the subject S is a living body, the portion detected as the magnification target SP is any one of the eye, the face, or the head of the subject S. In a case where the subject S is a living body, since the focusing state of the eye, the face, or the like is important in many cases, it is possible to perform the display that matches the needs of the user.

In addition, a determination cycle for determining whether or not to execute the overlapping degree reduction processing corresponds to any one of the refresh rate of the display screen or the frame rate of the image 36 captured by the imaging sensor 20. Therefore, the real-time performance of the overlapping degree reduction is improved as compared with a case where the cycle is longer than the refresh rate or the frame rate.

In addition, the processor 40 of the imaging apparatus 10 starts the PIP display and starts the display of the magnification region LPA in a case where the focusing operation is started. In addition, in a case where the focusing operation is ended, the PIP display is ended and the display of the magnification region LPA is ended. Since the display of the magnification region LPA is performed in accordance with the timing of the start or the end of the focusing operation, it is easy to check the focusing state. In addition, the processor 40 starts or ends the display of the magnification region LPA based on the operation of the release button 22. Since the focusing operation is often performed in response to the operation of the release button 22, the convenience is high by linking the display of the magnification region LPA to the operation of the release button 22.

It should be noted that the display is not limited to the focusing operation of the magnification region LPA and may be performed in an imaging operation other than the focusing operation. For example, the PIP display may be performed to display the magnification region LPA in a case where the live view display is performed in the video image capturing mode. The live view display including the magnification region LPA may be performed in both a standby state of the video image capturing and a video image recording.

It should be noted that, in the above-described embodiment, the display control unit 53 performs the live view display on the finder 14 and performs the PIP processing in the live view display, but the live view display may be performed on the display 15 instead of the finder 14 or together with the finder 14.

### Various Modification Examples

In addition, the disclosed technology is not limited to the above-described embodiment, and various modifications can be made as described below.

### Modification Example 1

### Changing Threshold Value According to Subject Portion in Overlapping Region

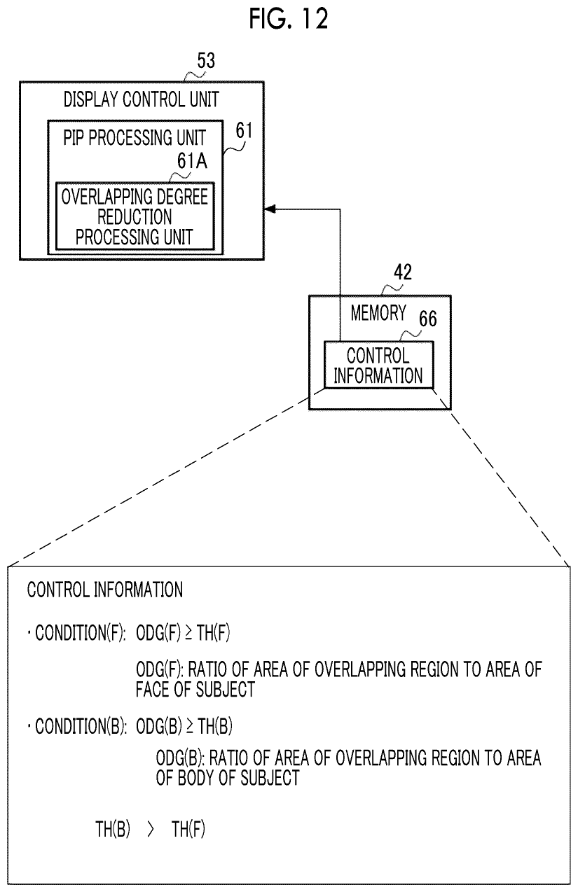

In the above-described embodiment, the example has been described in which the threshold value TH is uniformly determined as the condition for executing the overlapping degree reduction processing as shown in FIG. 10, but the threshold value TH may be changed according to the portion of the subject S in the overlapping region OV as shown in FIG. 12. The example shown in FIG. 12 is an example in which two conditions, a condition (F) in a case where the portion of the subject S in the overlapping region OV is a face and a condition (B) in a case where the portion of the subject S in the overlapping region OV is a body, are set. The overlapping degree ODG (F) is a proportion of the area of the overlapping region OV to the area of the face of the subject S, and the overlapping degree ODG (B) is a proportion of the area of the overlapping region OV to the area of the body of the subject S. The threshold value TH is also set to each of a threshold value TH (B) in a case of the body and a threshold value TH (F) in a case of the face.

In the example of FIG. 12, the threshold value TH (B) of the body is larger than the threshold value TH (F) of the face. Therefore, in a case where the comparison is simply made by the proportion of the area, the overlapping degree reduction processing is not executed in a case where the overlapping degree ODG (B) of the body is not larger than the overlapping degree ODG (F) of the face.

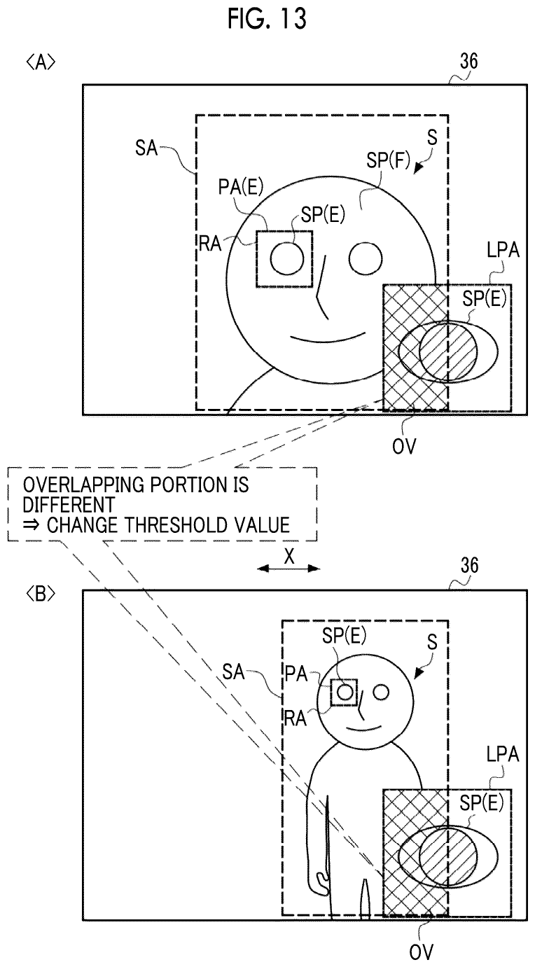

The description will be made using a specific example shown in FIG. 13. The diagram of <A> in the upper part of FIG. 13 is an example in which the magnification region LPA in which the magnification target SP is the eye SP (E) overlaps with the subject region SA in which the close-up of the face is shown, and the overlapping region OV includes the face SP (F) of the subject S. On the other hand, the diagram of <B>in the lower part of FIG. 13 is an example in which the same magnification region LPA overlaps with the subject region SA in which the substantially whole body of the subject S is shown, and the overlapping region OV includes the portion of the body. In the examples of <A> and <B>, the areas of the overlapping regions OV are the same.

As shown in FIG. 12, the threshold value TH (F) in a case where the portion of the subject S in the overlapping region OV is the face SP (F) is smaller than the threshold value TH (B) in a case of the body. Therefore, for example, even in a case where the areas of the overlapping regions OV are the same, the overlapping degree reduction processing is executed in a case where the overlapping region OV is the face, but the overlapping degree reduction processing is not executed in a case where the overlapping region OV is the body, and thus whether or not the overlapping degree reduction processing is executed is changed depending on the portion of the subject S.

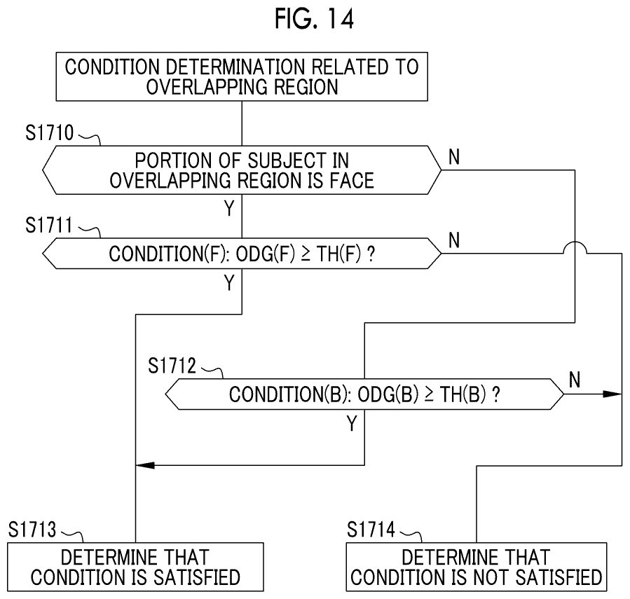

A specific processing procedure is shown in FIG. 14 as an example. FIG. 14 is a flowchart showing a more detailed procedure related to step S1700 shown in FIG. 11. In FIG. 14, the overlapping degree reduction processing unit 61A determines whether or not the portion of the subject S in the overlapping region OV is the face in step S1710 in the condition determination related to the overlapping region OV. In a case where it is determined that the portion of the subject S is the face (Y in step S1710), the processing proceeds to step S1711, and it is determined whether or not a condition (F) corresponding to the face is satisfied. In a case where the condition (F) is satisfied, the processing proceeds to step S1713, and it is determined that the condition is satisfied. In a case where the condition (F) is not satisfied, the processing proceeds to step S1714, and it is determined that the condition is not satisfied.

On the other hand, in a case where it is determined that the portion of the subject S is not the face in step S1710, the overlapping degree reduction processing unit 61A proceeds to step S1712, and determines whether or not a condition (B) corresponding to the body is satisfied. As in a case of the condition (F), in a case of the condition (B), the processing proceeds to step S1713 or step S1714 according to a determination result in step S1712. The determination results in step S1713 and step S1714 correspond to the determination result in step S1700 shown in FIG. 11.

Although the feeling varies depending on the user, for example, in a case where the composition is checked, the overlapping region OV that occurs in the face SP(F) of the subject S is noticeable, but the overlapping region OV that occurs in the body is not so noticeable, and thus the user's tolerance for the overlapping region OV may vary depending on the portion of the subject S. As shown in FIG. 12, by making it possible to change the threshold value TH according to the portion of the subject S in the overlapping region OV, it is possible to flexibly respond to the user's tolerance.

In a case of Modification Example 1, the overlapping degree reduction processing unit 61A uses the detection result of the subject detection unit 64 for the recognition of the portion in the overlapping region OV. For example, the subject detection unit 64 performs the recognition of the portion, such as whether the portion of the detected subject S is the face or the body, by using an object recognition technique using AI, and outputs the detection result including the recognition result to the overlapping degree reduction processing unit 61A. The overlapping degree reduction processing unit 61A can also ascertain information regarding the portion included in the subject region SA and the portion of the magnification target SP included in the target region PA, and information regarding the portion in the overlapping region OV, based on the recognition result from the subject detection unit 64.

### Modification Example 2

### Changing Threshold Value According to Area of Subject Region

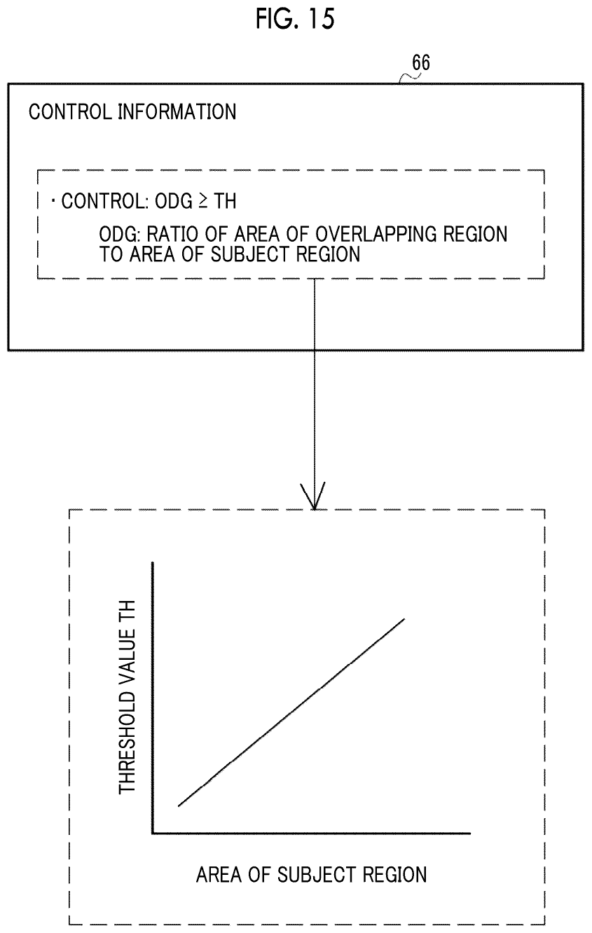

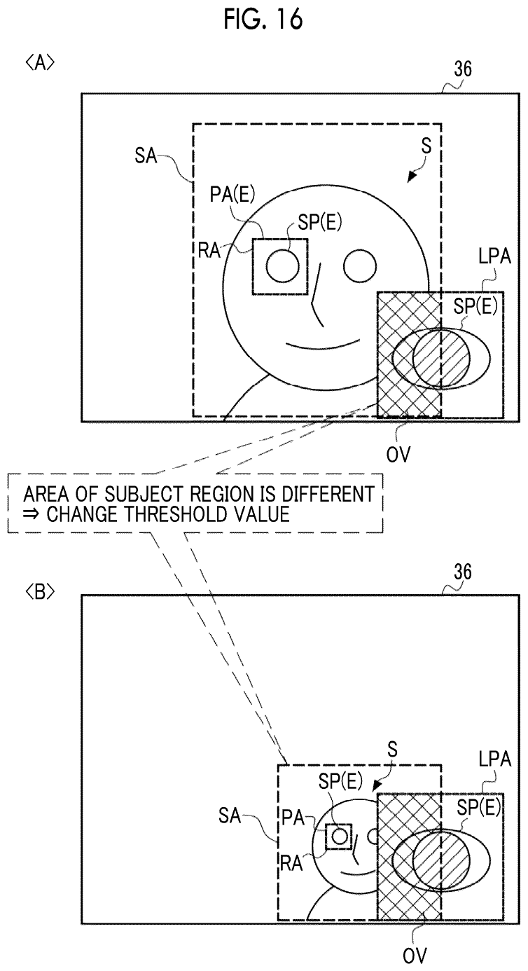

Further, as shown in FIGS. 15 and 16, even in a case where the portion of the subject S in the overlapping region OV is the same, the threshold value TH may be changeable according to the area of the subject region SA representing the subject S in the image 36. The condition shown in FIG. 15 is the same as the condition shown in FIGS. 10 and 12, and the overlapping degree ODG is a ratio of the area of the overlapping region OV to the area of the subject region SA. Modification Example 2 is an example in which the value of the threshold value TH to be compared with the overlapping degree ODG is changeable according to the area of the subject region SA. As shown in the graph of FIG. 15, for example, the larger the area of the subject region SA, the larger the threshold value TH.

FIG. 16 showing a specific example shows an up-close view of the face as the subject S, and a region including the face and the shoulder is the subject region SA. In the upper part of FIG. 16 showing <A> and the lower part of FIG. 16 showing <B>, the areas of the magnification regions LPA are the same, and the areas of the overlapping regions OV are also the same. However, the areas of the subject regions SA are different, and the area of the subject region SA in the upper part of FIG. 16 showing <A> is larger. Here, the overlapping degree ODG(F) is defined as a ratio of the area of the overlapping region OV to the area of the subject region SA.

In such a case, in a case where the threshold value TH is constant, from the definition of the overlapping degree ODG, in a case where the area of the overlapping region OV as the numerator is the same, the smaller the area of the subject region SA as the denominator, the larger the overlapping degree ODG, and thus the condition is likely to be satisfied. In a case where the condition is satisfied, the overlapping degree reduction processing is executed. In a case where the frequency of the overlapping degree reduction processing is high, hunting in which the movement of the insertion position of the magnification region LPA or the change of the display size is frequently repeated is likely to occur. Specifically, as shown in <B> of the lower part of FIG. 16, the overlapping degree ODG is larger in a case where the area of the subject region SA is smaller than that in <A> of the upper part, and the condition is likely to be satisfied, and thus the hunting is likely to occur. Since the magnification region LPA is used for checking the focusing state, it is preferable that the size and the insertion position of the magnification region LPA do not frequently change regardless of the size of the subject region SA.

Therefore, in Modification Example 2, as shown in the graph of FIG. 15 as an example, the threshold value TH is changed according to the area of the subject region SA such that the threshold value TH is smaller as the area of the subject region SA is smaller. In this manner, even in a case where the subject region SA is small, the hunting can be suppressed.

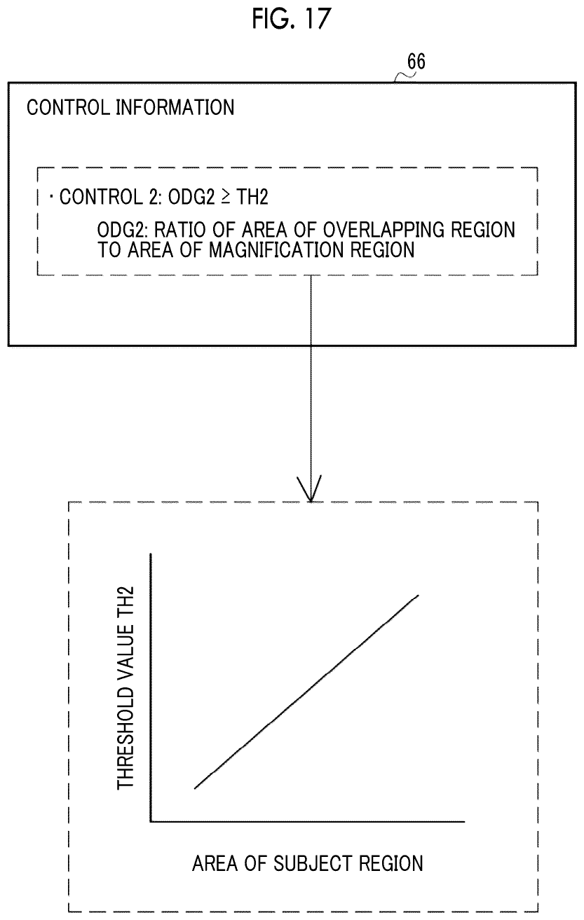

In Modification Example 2, the overlapping degree ODG is defined as the proportion of the area of the overlapping region OV to the area of the subject region SA, but may be the proportion of the area of the overlapping region OV to the area of the magnification region LPA as in an overlapping degree ODG2 shown in FIG. 17. Even in this case, the hunting can be suppressed by making it possible to change the threshold value TH according to the area of the subject region SA.

For example, as shown in FIG. 16, the larger the subject region SA is, the larger the area occupied by the subject region SA in the image 36 is. Therefore, in <A> of the upper part, the space for inserting the magnification region LPA while avoiding the subject region SA is smaller than that in <B> of the lower part. Therefore, the probability that the subject region SA overlaps with the magnification region LPA is increased. In a case where the subject region SA is small, the area occupied by the subject region SA in the image 36 is small. Therefore, there is a relatively large margin in the space for inserting the magnification region LPA while avoiding the subject region SA.

In this manner, in a case where the subject region SA is large, the overlapping is likely to occur. Therefore, the area of the overlapping region OV overlapping with the magnification region LPA (the numerator of the overlapping degree ODG2) is also increased, and the overlapping degree ODG2 is likely to be increased as compared to a case where the subject region SA is small. In particular, in a case where the subject S frequently moves, in a case where the subject S is large, the area of the overlapping region OV is likely to be increased even in a case where the subject S slightly moves. As a result, the hunting is likely to occur.

Therefore, even in a case where the overlapping degree ODG2 having the magnification region LPA as the denominator is used in this manner, as shown in the graph of FIG. 17, the threshold value TH2 is increased as the subject region SA is larger. By changing the threshold value TH2 in this manner, it is possible to suppress the hunting in a case where the subject region SA is large.

### Modification Example 3

### Modification Example of Overlapping Degree

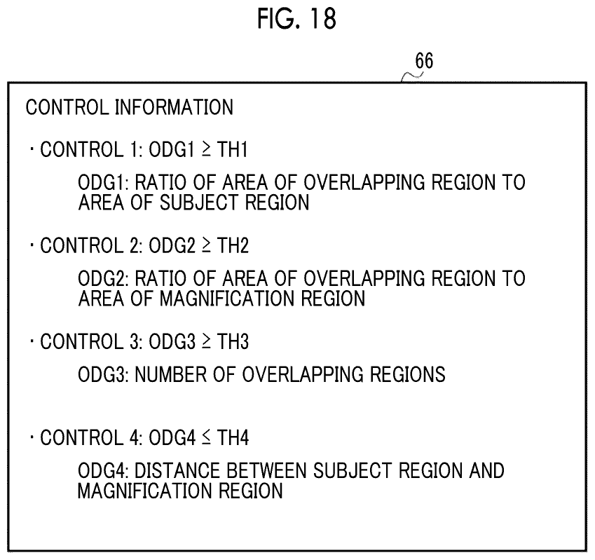

As shown in FIG. 18, various conditions such as a condition 1 to a condition 4 may be considered as the condition for determining whether or not to execute the overlapping degree reduction processing, and any of the conditions may be used. The condition 1 is the same as the condition shown in FIGS. 10 and 12, and is a condition in which the proportion of the area of the overlapping region OV to the area of the subject region SA is set as the overlapping degree ODG1 as the numerical indicator. As shown in FIG. 17, the condition 2 is a condition in which the proportion of the area of the overlapping region OV to the area of the magnification region LPA is set as the overlapping degree ODG2 as the numerical indicator.

In addition, the condition 3 is a condition in which the number of overlapping regions OV is set as the overlapping degree ODG3 as the numerical indicator. As the number of overlapping regions OV is reduced, the overlapping degree ODG3 is reduced. Therefore, the overlapping degree reduction processing is executed in a case where the overlapping degree ODG3 is equal to or greater than a threshold value TH3. In addition, the condition 4 is a condition in which the distance between the subject region SA and the magnification region LPA is set as the overlapping degree ODG4 as the numerical indicator. In a case of the condition 4, as the distance is longer, the overlapping degree ODG4 is reduced. Therefore, the overlapping degree reduction processing is executed in a case where the overlapping degree ODG4 is equal to or less than a threshold value TH4.

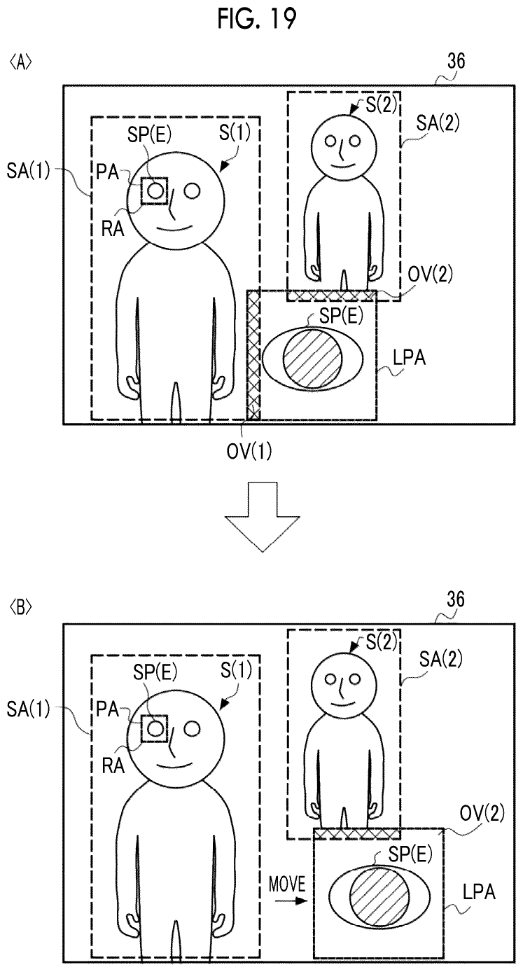

FIG. 19 is a specific example in a case where the condition 3 is used. In the example shown in FIG. 19, the image 36 includes a plurality of first subjects S(1) and second subjects S(2), and the magnification region LPA corresponding to the first subject S(1) is inserted. Then, as shown in the diagram of <A> in the upper part of FIG. 19, two overlapping regions OV, that is, an overlapping region OV(1) with a first subject region SA(1) representing the first subject S(1) and an overlapping region OV(2) with a second subject region SA(2) representing the second subject S(2), are generated. In this case, in a case where the threshold value TH3 is “2”, the condition 3 is satisfied. Therefore, as shown in the diagram of <B> in the lower part of FIG. 19, the overlapping degree reduction processing unit 61A executes the overlapping degree reduction processing of moving the insertion position of the magnification region LPA to reduce the number of overlapping regions OV to one.

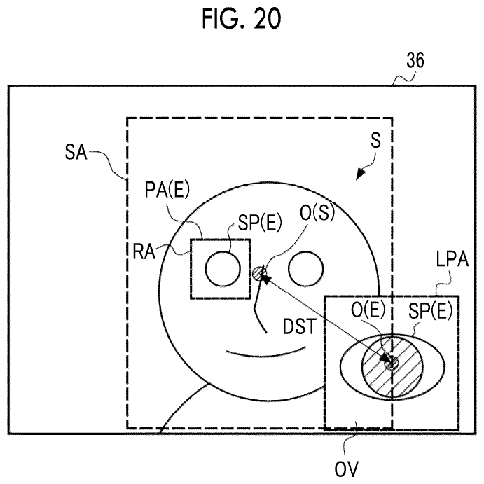

FIG. 20 is a specific example in a case where the condition 4 is used. In the example shown in FIG. 20, the overlapping region OV between the subject region SA and the magnification region LPA is generated. The overlapping degree reduction processing unit 61A obtains a distance DST between a center O(S) of the subject region SA and a center O(E) of the magnification region LPA, and uses the distance DST as the overlapping degree ODG4. In a case where the overlapping degree ODG4 is equal to or less than the threshold value TH4, it is considered that the subject region SA and the magnification region LPA are in a state of being close to each other and the degree of overlap is large. Therefore, in a case where the overlapping degree ODG4 is equal to or less than the threshold value TH4, the overlapping degree reduction processing unit 61A executes the overlapping degree reduction processing by moving the insertion position of the magnification region LPA in a direction in which the distance DST is increased or reducing the display size.

The distance DST may be a distance between the centroids of the subject S included in the subject region SA and the magnification target SP included in the magnification region LPA.

### Modification Example 4

### Method of Calculating Overlapping Region

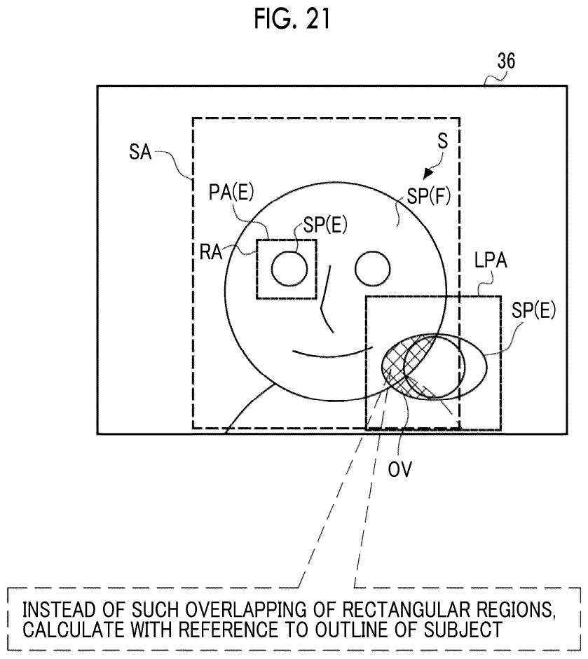

In the above-described embodiment, as a method of calculating the area of the overlapping region OV, the area of the region in which the rectangular regions of the subject region SA and the magnification region LPA overlap each other is calculated. Instead of such overlapping of the rectangular regions, the overlapping region OV may be calculated with reference to the outline of the subject S as shown in FIG. 21. Here, the calculation with reference to the outline is a method of calculating the overlapping region OV by obtaining the outline of the face SP(F) of the subject S and the outline of the eye SP(E) of the subject S and calculating the region in which the internal regions defined by the outlines overlap each other. According to this method, an accurate overlapping portion can be obtained as compared with a case of performing the calculation in the rectangular region.

### Modification Example 5

### Priority of Insertion Position

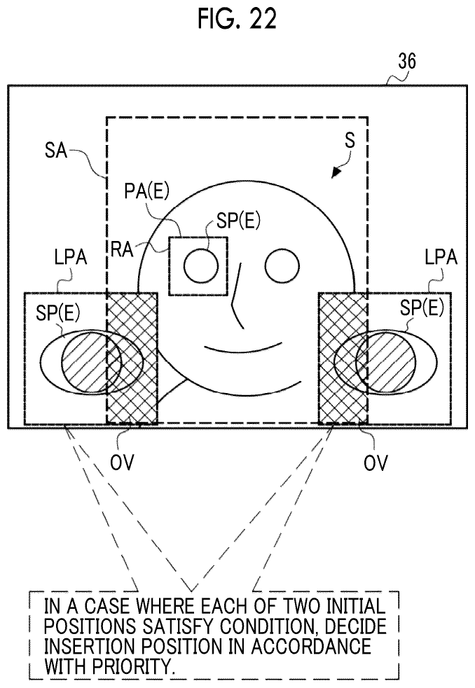

As shown in FIG. 22, in a case where a plurality of initial positions are set as the insertion positions of the magnification region LPA with priorities, the PIP processing unit 61 of the processor 40 may decide the insertion position in accordance with the priority in a case where each of the plurality of initial positions satisfies the condition.

As shown in the control information 66 of FIG. 10, a plurality of initial positions may be set as the initial positions of the insertion positions of the magnification region LPA, such as a lower right corner or a lower left corner. In this case, the PIP processing unit 61 selects, for example, the initial position having a smaller overlapping degree ODG from among the plurality of initial positions. However, as shown in FIG. 22, there is a case where both the plurality of initial positions satisfy the condition related to the overlapping region OV and the overlapping degrees ODG are the same. In such a case, the PIP processing unit 61 may decide the insertion position in accordance with the priorities set for the plurality of initial positions. As shown in the control information 66 of FIG. 10, the plurality of initial positions are set with priorities. In the example of FIG. 10, the lower right corner is first and the lower left corner is second. Therefore, in a case where the overlapping degrees ODG of both the plurality of initial positions are the same, the PIP processing unit 61 decides the insertion position at the lower right corner having a higher priority. In this way, by setting the priority, it is easier to decide the final insertion position as compared with a case where the priority is not set.

### Modification Example 6

### Determination Processing of Overlapping Region in Case of Plurality of Subjects

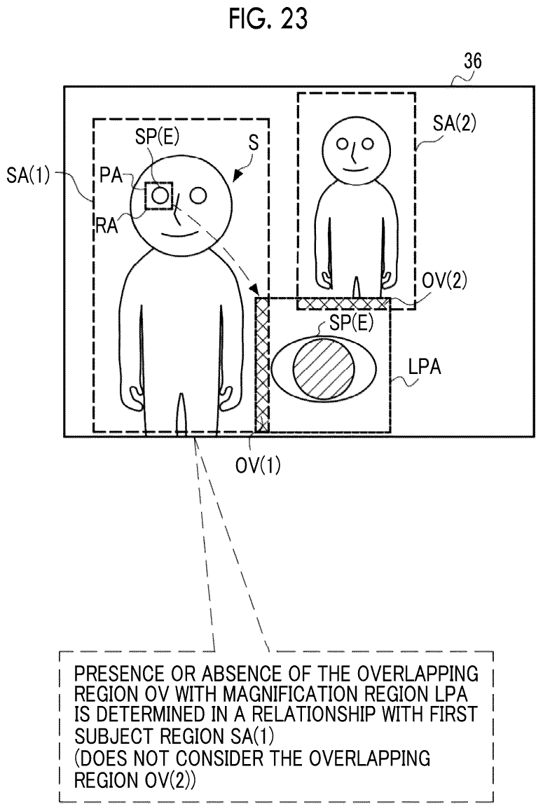

As shown in FIG. 23, in a case where a plurality of subjects S are included in the image 36 and at least one magnification target SP of a plurality of first subjects S(1) and second subjects S(2) is inserted as the magnification region LPA, the PIP processing unit 61 of the processor 40 may determine the presence or absence of the overlapping region OV based on a relationship between the magnification region LPA and the subject region (in the present example, the first subject region SA(1)) corresponding to the magnification region. That is, the PIP processing unit 61 considers only the overlapping region OV(1) with the first subject region SA(1) and does not consider the overlapping region OV(2) with the second subject region SA(2) that does not correspond to the magnification region LPA. Accordingly, the determination of the overlapping region OV is prevented from being complicated.

### Modification Example 7

### Determination Processing of Overlapping Region in Case of Plurality of Subjects

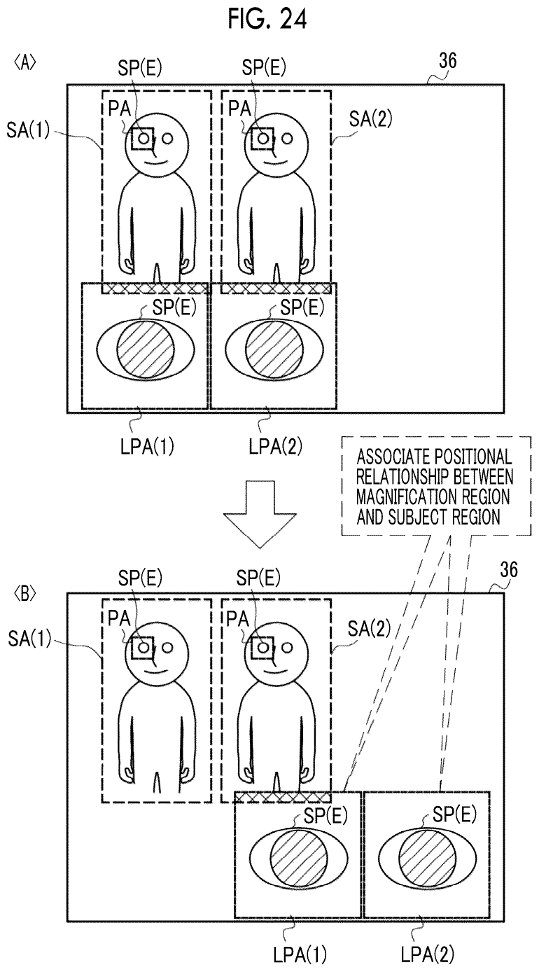

As shown in FIG. 24, a case is considered in which the first subject S(1) and the second subject S(2) are included in the image 36 as the subjects S and a first magnification region LPA(1) that is the magnification region LPA corresponding to the eye SP(E) that is the magnification target SP of the first subject S(1) and a second magnification region LPA(2) that is the magnification region LPA corresponding to the eye SP(E) that is the magnification target SP of the second subject S(2) are inserted. In this case, the PIP processing unit 61 of the processor 40 may decide a positional relationship between the first magnification region LPA(1) and the second magnification region LPA(2) based on a positional relationship between the first subject region SA(1) representing the first subject S(1) and the second subject region SA(2) representing the second subject S(2) in the image 36.

As shown in the diagram of <A> in the upper part of FIG. 24, the positional relationship between the first subject S(1) and the second subject S(2) is that the first subject S(1) is positioned on the left side and the second subject S(2) is positioned on the right side. The positional relationship between the first magnification region LPA(1) and the second magnification region LPA(2) is also that the first magnification region LPA(1) is inserted on the left side and the second magnification region LPA(2) is inserted on the right side. A case is considered in which the PIP processing unit 61 executes the overlapping degree reduction processing by moving the insertion positions of the first magnification region LPA(1) and the second magnification region LPA(2). Even in this case, as shown in the diagram of <B> in the lower part of FIG. 24, the PIP processing unit 61 causes the positional relationship between the first magnification region LPA(1) and the second magnification region LPA(2) at the movement destination to correspond to the positional relationship between the first subject S(1) and the second subject S(2). As described above, in a case in which the positional relationship between the plurality of magnification regions LPA and the positional relationship between the subjects S corresponding to the respective magnification regions LPA correspond to each other, it is easy to intuitively understand which subject S the magnification region LPA corresponds to.

### Modification Example 8

### Hunting Countermeasure Using Dead Zone

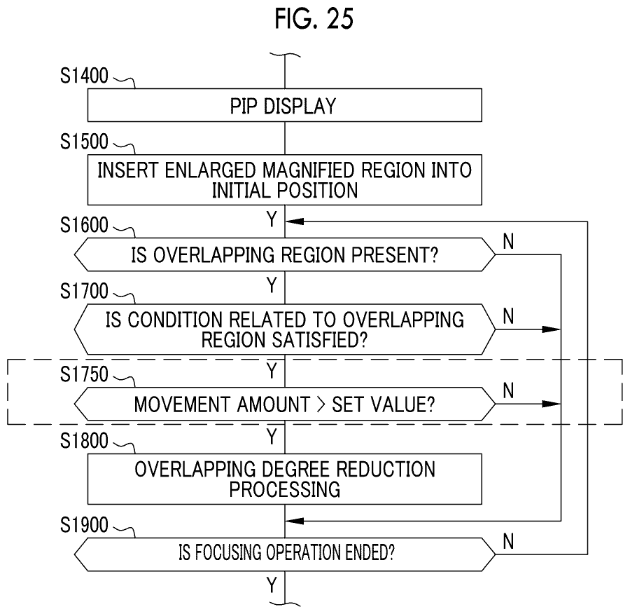

As shown in FIG. 25, in a case in which the movement amount and the reduction rate of the magnification region LPA decided in the overlapping degree reduction processing are equal to or less than the set values set in advance even in a case in which the condition is satisfied, the PIP processing unit 61 of the processor 40 may not execute the overlapping degree reduction processing. In the flowchart of FIG. 25, the steps other than step S1750 are the same as the flowchart shown in FIG. 11. In a case in which it is determined in step S1700 that the condition related to the overlapping region OV is satisfied (Y in step S1700), the PIP processing unit 61 proceeds to step S1750. Then, in step S1750, for example, in a case in which the movement amount of the magnification region LPA for eliminating the overlapping region OV exceeds the set value set in advance (Y in step S1750), the overlapping degree reduction processing is executed, but in a case in which the movement amount is equal to or less than the set value (N in step S1750), the overlapping degree reduction processing is not executed. By setting the dead zone for limiting the movement of the magnification region LPA in a case in which the movement amount is small, it is possible to suppress the hunting in which the magnification region LPA frequently and minutely moves. Of course, the same applies to a case in which the reduction rate is small instead of the movement amount. The size of the set value is decided to be an appropriate size as the dead zone.

### Modification Example 9

### Hunting Countermeasure due to Detection Accuracy

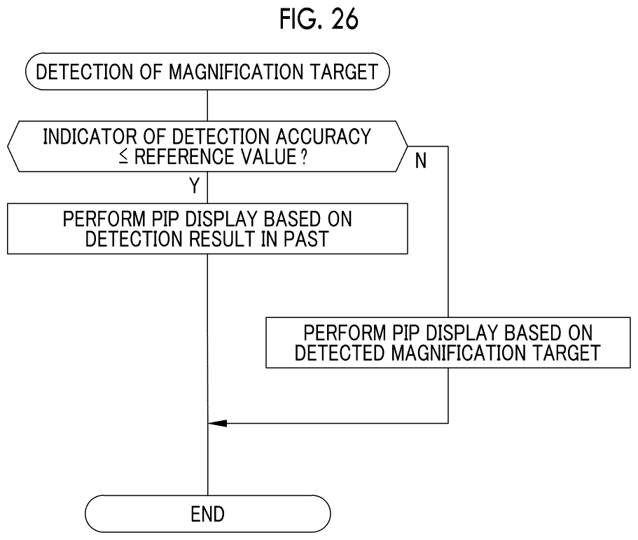

As shown in FIG. 26, in a case in which the detection of the magnification target SP from the image 36 is repeatedly performed, the PIP processing unit 61 of the processor 40 may execute at least one of the decision of the magnification target SP or the decision of the content of the overlapping degree reduction processing based on the detection result in the past in a case in which the indicator related to the accuracy of the detection of the magnification target SP is equal to or less than the reference set in advance. In a case in which the detection of the magnification target SP is unstable, the hunting in which the display and the non-display of the magnification region LPA are repeated may occur. The example shown in FIG. 26 is an example in which the detection result in the past is used as the hunting countermeasure due to such detection accuracy.

As shown in FIG. 26, the PIP processing unit 61 compares the indicator of the detection accuracy of the magnification target SP with the reference value, and performs the PIP display based on the detection result in the past in a case in which the indicator is equal to or less than the reference value. Specifically, the PIP processing unit 61 executes at least one of the decision of the magnification target SP or the decision of the content of the overlapping degree reduction processing such as the decision of the insertion position based on the detection result in the past. For example, the PIP processing unit 61 records the detection rate as the indicator of the detection accuracy. The detection rate is, for example, a ratio of the number of times of detection to the number of frames in a case in which the detection of the magnification target SP is performed in accordance with the frame rate at which the imaging sensor 20 acquires the image 36. The detection result in the past is, for example, a history of the detection position of the eye SP (E) in a case in which the eye SP (E) is detected. In a case in which the detection rate of the magnification target SP is equal to or less than the reference value, the PIP processing unit 61 predicts the position of the magnification target SP based on the detection result in the past, and detects the predicted region as the magnification target SP. In addition, the PIP processing unit 61 decides the insertion position of the magnification region LPA to avoid the predicted position of the magnification target SP. Accordingly, it is possible to suppress the hunting due to the detection accuracy.

### Modification Example 10

### Decision of Magnification Target According to Size of Subject

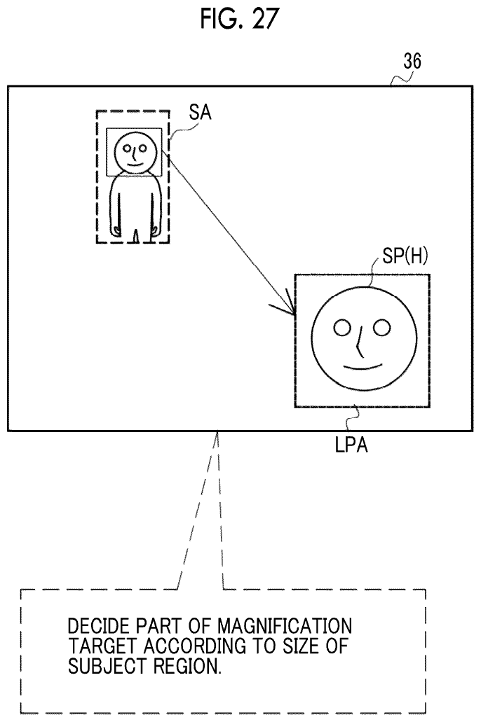

The PIP processing unit 61 of the processor 40 may decide the part of the subject S to be the magnification target SP according to the size of the subject S in the image 36. For example, as shown in FIG. 27, in a case in which the size of the subject S in the image 36 is small, even in a case in which the eye is detected as the magnification target SP, the resolution may be too coarse to check the in-focus state. Therefore, as an example, in a case in which the size of the subject S is small, the PIP processing unit 61 decides the face larger than the eye as the part of the magnification target SP. Accordingly, it is easy to check the in-focus state.

### Modification Example 11

### Improvement of Visibility of Magnification Region

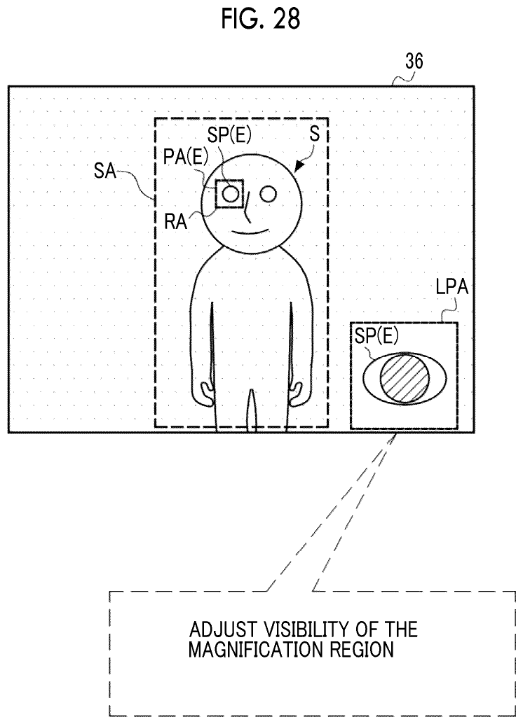

As shown in FIG. 28, the PIP processing unit 61 of the processor 40 may adjust the visibility of the magnification region LPA separately from the subject region SA. For example, the visibility of the magnification region LPA is improved by performing the brightness correction or the color correction of the magnification region LPA independently of the subject region SA. The example of FIG. 28 shows a state in which the visibility of the magnification region LPA is improved as compared with the region (including the subject region SA) other than the magnification region LPA in the image 36.

### Modification Example 12

### Transparency

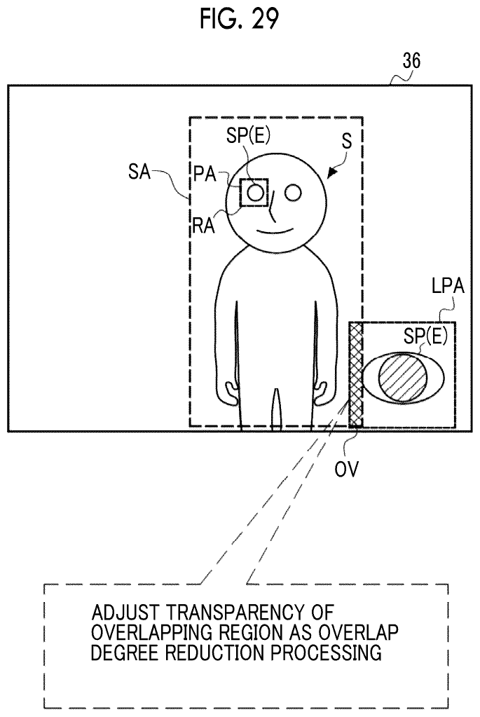

In addition, as shown in FIG. 29, as the overlapping degree reduction processing, processing of adjusting the transparency of the overlapping region OV may be performed. For example, in a case in which the magnification region LPA is displayed on the front surface with respect to the subject region SA, the transparency of the magnification region LPA is increased, so that the subject region SA can be faintly checked. As described above, the overlapping degree reduction processing includes the processing of adjusting the transparency.

In the above-described embodiment, the numerical indicator is described as an example of the indicator representing the overlapping degree ODG, but, for example, an indicator other than the numerical value, such as large, medium, and small, may be used. In this case, the threshold value TH is also set with the content that the overlapping degree ODG is “medium” or more.

Note that the technology of the present disclosure is not limited to the digital camera and can also be applied to electronic devices such as a smartphone and a tablet terminal having an imaging function.

The following technology can be understood based on the above description.

### Supplementary Note 1

A display control device comprising:
a processor,
in which the processor acquires an image including a subject,
detects, in addition to a subject region representing the subject, at least a part of the subject as a magnification target from the image,
inserts, in a display screen on which the image is displayed, a magnification region in which a target region representing the magnification target is magnified, into the display screen, and
executes, in a case where an overlapping region in which the subject region and the magnification region overlap with each other is generated on the display screen and a condition is satisfied, overlapping degree reduction processing of reducing an overlapping degree of the overlapping region.

### Supplementary Note 2

The display control device according to Supplementary Note 1,
in which the processor executes the overlapping degree reduction processing by adjusting at least one of a display size or an insertion position of the magnification region.

### Supplementary Note 3

The display control device according to Supplementary Note 1 or 2,
in which, in the overlapping region, the magnification region is displayed in front of the subject region.

### Supplementary Note 4

The display control device according to Supplementary Note 3,
in which the condition is defined by a magnitude relationship between a numerical indicator indicating the overlapping degree and a threshold value.

### Supplementary Note 5

The display control device according to Supplementary Note 4,
in which the numerical indicator includes any one of a ratio of an area of the overlapping region to an area of the subject region or an area of the magnification region, the number of the overlapping regions, or a distance between the subject region and the magnification region.

### Supplementary Note 6

The display control device according to Supplementary Note 4 or 5,
in which the threshold value is changeable according to a portion of the subject in the overlapping region.

### Supplementary Note 7

The display control device according to Supplementary Note 5 or 6,
in which the numerical indicator is a ratio of an area of the overlapping region to an area of the subject region or an area of the magnification region, and the threshold value is changeable according to the area of the subject region.

### Supplementary Note 8

The display control device according to any one of Supplementary Notes 1 to 7,
in which, in a case where the subject region is detected as a rectangular region including the subject,
the processor determines at least one of presence or absence of the overlapping region or whether or not the condition is satisfied, based on the overlap between the rectangular region and the magnification region.

### Supplementary Note 9

The display control device according to Supplementary Note 8,
in which the target region is also detected as a rectangular region including the magnification target.

### Supplementary Note 10

The display control device according to any one of Supplementary Notes 1 to 9,
in which, in a case where a plurality of the subjects are included in the image and at least one magnification target among the plurality of subjects is inserted as the magnification region,
the processor determines presence or absence of the overlapping region based on a relationship between the magnification region and a subject region corresponding to the magnification region.

### Supplementary Note 11

The display control device according to any one of Supplementary Notes 1 to 10,
in which, in a case where a first subject and a second subject are included in the image as the subjects, and a first magnification region that is the magnification region corresponding to the magnification target of the first subject and a second magnification region that is the magnification region corresponding to the magnification target of the second subject are inserted,
the processor determines a positional relationship between the first magnification region and the second magnification region based on a positional relationship between a first subject region representing the first subject and a second subject region representing the second subject in the image.

### Supplementary Note 12

The display control device according to any one of Supplementary Notes 1 to 11,
in which, in a case where a plurality of initial positions are set as insertion positions of the magnification region with priorities assigned,
the processor determines the insertion position according to the priority in a case where each of the plurality of initial positions satisfies the condition.

### Supplementary Note 13

The display control device according to any one of Supplementary Notes 1 to 12,
in which, in a case where the subject is a biological body, a portion detected as the magnification target is any one of an eye, a face, or a head of the subject.

### Supplementary Note 14

The display control device according to any one of Supplementary Notes 1 to 13,
in which a determination cycle of whether or not to execute the overlapping degree reduction processing corresponds to any one of a refresh rate of the display screen or a frame rate of the image.

### Supplementary Note 15

The display control device according to any one of Supplementary Notes 1 to 14,
in which, the processor does not execute the overlapping degree reduction processing in a case where a movement amount and a reduction rate of the magnification region determined in the overlapping degree reduction processing are equal to or less than preset set values, even in a case where the condition is satisfied.

### Supplementary Note 16

The display control device according to any one of Supplementary Notes 1 to 15,
in which, in a case where the detection of the magnification target from the image is repeatedly performed,
the processor executes at least one of determination of the magnification target or determination of content of the overlapping degree reduction processing based on a past detection result in a case where an indicator related to accuracy of the detection of the magnification target is equal to or less than a preset reference.

### Supplementary Note 17

The display control device according to any one of Supplementary Notes 1 to 16,
in which the overlapping degree reduction processing includes processing of adjusting a transparency of the overlapping region.

### Supplementary Note 18

The display control device according to any one of Supplementary Notes 1 to 17,
in which the processor determines a portion of the subject as the magnification target according to a size of the subject in the image.

### Supplementary Note 19

The display control device according to any one of Supplementary Notes 1 to 18,
in which the processor adjusts visibility of the magnification region separately from the subject region.

### Supplementary Note 20

An imaging apparatus including the display control device according to any one of Supplementary Notes 1 to 19,
in which the processor starts display of the magnification region in a case where an imaging operation is started.

### Supplementary Note 21

The imaging apparatus according to Supplementary Note 20,
in which the imaging operation is a focusing operation.

### Supplementary Note 22

The imaging apparatus according to Supplementary Note 20 or 21,
in which the processor ends the display of the magnification region in a case where the imaging operation ends.

### Supplementary Note 23

The imaging apparatus according to any one of Supplementary Notes 20 to 22,
in which the processor starts or ends the display of the magnification region based on an operation of a release button.

### Supplementary Note 24

An operation method of a display control device including a processor, comprising:
via the processor
acquiring an image including a subject;
detecting, in addition to a subject region representing the subject, at least a part of the subject as a magnification target from the image;
inserting, in a display screen on which the image is displayed, a magnification region in which a target region representing the magnification target is magnified, into the display screen; and
executing, in a case where an overlapping region in which the subject region and the magnification region overlap with each other is generated on the display screen and a condition is satisfied, overlapping degree reduction processing of reducing an overlapping degree of the overlapping region.

### Supplementary Note 25

An operation program of a display control device including a processor, the operation program causing the processor to execute a process of:
acquiring an image including a subject;
detecting, in addition to a subject region representing the subject, at least a part of the subject as a magnification target from the image;
inserting, in a display screen on which the image is displayed, a magnification region obtained by magnifying a target region representing the magnification target into the display screen; and
executing, in a case where an overlapping region in which the subject region and the magnification region overlap with each other is generated on the display screen and a condition is satisfied, overlapping degree reduction processing of reducing an overlapping degree of the overlapping region.

In the above-described embodiment, as the hardware structure of the control unit using the processor 40 as an example, various processors to be described below can be used. The above-described various processors include not only a CPU which is a general-purpose processor that functions by executing software (programs) but also a processor that has a changeable circuit configuration after manufacturing, such as an FPGA. The FPGA includes a dedicated electric circuit, which is a processor having a circuit configuration specially designed for executing a specific processing, such as PLD or ASIC.

The control unit may be configured with one of these various processors or a combination of two or more of the processors of the same type or different types (for example, a combination of a plurality of FPGAs or a combination of a CPU and an FPGA). Further, the plurality of control units may be constituted of one processor.

A plurality of examples in which a plurality of controllers are configured as one processor can be considered. In the first example, as represented by computers such as a client and a server, there is a form in which one processor is constituted of a combination of one or more CPUs and software and this processor functions as a plurality of control units. As a second example, as typified by system on chip (SOC), there is a form in which a processor that implements the functions of the whole system which includes a plurality of control units with one IC chip is used. As described above, the control unit can be configured by using one or more of the above-mentioned various processors as a hardware-like structure.

Additionally, as the hardware structure of these various processors, more specifically, it is possible to use an electrical circuit in which circuit elements such as semiconductor elements are combined.

The disclosed technology can also appropriately combine various embodiments and/or various modification examples described above. The disclosed technology is not limited to the above embodiment and may adopt various configurations without departing from its gist. In addition to the program, the disclosed technology also applies to a non-transitory storage medium that stores the program. The storage medium is, for example, a non-transitory computer-readable storage medium such as a universal serial bus (USB) memory, a flexible disk, or a compact disc read only memory (CD-ROM). The program may be provided online through a network such as the Internet. The disclosed technology also applies to a program product in addition to the program. The program product includes products in any aspect for providing the program. Like the program, the program product may be provided by being stored in a non-transitory computer-readable storage medium or may be provided online.

The above-described contents and the above-shown contents are detailed descriptions for parts according to the technology of the present disclosure, and are merely examples of the present disclosed technology. For example, description related to the above configurations, functions, actions, and effects is description related to examples of configurations, functions, actions, and effects of the parts according to the present disclosed technology. Accordingly, in the contents described and the contents shown hereinabove, it is needless to say that removal of an unnecessary part, or addition or replacement of a new element may be employed within a range not departing from the gist of the present disclosed technology. In order to avoid complication and easily understand the parts relating to the present disclosed technology, in the content of the above description and the content of the drawings, the description regarding common general technical knowledge which is not necessarily particularly described in terms of embodying the present disclosed technology is omitted.

The disclosure of JP 2023-173228A filed on Oct. 4, 2023 is incorporated herein by reference in its entirety. In addition, all documents, patent applications, and technical standards described in the present specification are incorporated in the present specification by reference to the same extent as in a case where each document, patent application, and technical standard are specifically and individually noted to be incorporated by reference.

What is claimed is:

1. A display control device comprising:
a processor,
wherein the processor acquires an image including a subject,
detects, in addition to a subject region representing the subject, at least a part of the subject as a magnification target from the image,
inserts, in a display screen on which the image is displayed, a magnification region in which a target region representing the magnification target is magnified, into the display screen, and
executes, in a case where an overlapping region in which the subject region and the magnification region overlap with each other is generated on the display screen and a condition is satisfied, overlapping degree reduction processing of reducing an overlapping degree of the overlapping region.

2. The display control device according to claim 1,
wherein the processor executes the overlapping degree reduction processing by adjusting at least one of a display size or an insertion position of the magnification region.

3. The display control device according to claim 1,
wherein, in the overlapping region, the magnification region is displayed in front of the subject region, and the condition is defined by a magnitude relationship between a numerical indicator indicating the overlapping degree and a threshold value.

4. The display control device according to claim 3,
wherein the numerical indicator includes any one of a ratio of an area of the overlapping region to an area of the subject region or an area of the magnification region, the number of the overlapping regions, or a distance between the subject region and the magnification region.

5. The display control device according to claim 3,
wherein the threshold value is changeable according to a portion of the subject in the overlapping region.

6. The display control device according to claim 4,
wherein the numerical indicator is a ratio of an area of the overlapping region to an area of the subject region or an area of the magnification region, and the threshold value is changeable according to the area of the subject region.

7. The display control device according to claim 1,
wherein, in a case where the subject region is detected as a rectangular region including the subject,
the processor determines at least one of presence or absence of the overlapping region or whether or not the condition is satisfied, based on the overlap between the rectangular region and the magnification region.

8. The display control device according to claim 7,
wherein the target region is also detected as a rectangular region including the magnification target.

9. The display control device according to claim 1,
wherein, in a case where a plurality of the subjects are included in the image and at least one magnification target among the plurality of subjects is inserted as the magnification region,
the processor determines presence or absence of the overlapping region based on a relationship between the magnification region and a subject region corresponding to the magnification region.

10. The display control device according to claim 1,
wherein, in a case where a first subject and a second subject are included in the image as the subjects, and a first magnification region that is the magnification region corresponding to the magnification target of the first subject and a second magnification region that is the magnification region corresponding to the magnification target of the second subject are inserted,
the processor determines a positional relationship between the first magnification region and the second magnification region based on a positional relationship between a first subject region representing the first subject and a second subject region representing the second subject in the image.

11. The display control device according to claim 1,
wherein, in a case where a plurality of initial positions are set as insertion positions of the magnification region with priorities assigned,
the processor determines the insertion position according to the priority in a case where each of the plurality of initial positions satisfies the condition.

12. The display control device according to claim 1,
wherein a determination cycle of whether or not to execute the overlapping degree reduction processing corresponds to any one of a refresh rate of the display screen or a frame rate of the image.

13. The display control device according to claim 1,
wherein the processor does not execute the overlapping degree reduction processing in a case where a movement amount and a reduction rate of the magnification region determined in the overlapping degree reduction processing are equal to or less than preset set values, even in a case where the condition is satisfied.

14. The display control device according to claim 1,
wherein, in a case where the detection of the magnification target from the image is repeatedly performed,
the processor executes at least one of determination of the magnification target or determination of content of the overlapping degree reduction processing based on a past detection result in a case where an indicator related to accuracy of the detection of the magnification target is equal to or less than a preset reference.

15. The display control device according to claim 1,
wherein the overlapping degree reduction processing includes processing of adjusting a transparency of the overlapping region.

16. The display control device according to claim 1,
wherein the processor determines a portion of the subject as the magnification target according to a size of the subject in the image.

17. An imaging apparatus comprising:
the display control device according to claim 1,
wherein the processor starts display of the magnification region in a case where an imaging operation is started.

18. The imaging apparatus according to claim 17,
wherein the processor ends the display of the magnification region in a case where the imaging operation ends.

19. An operation method of a display control device including a processor, comprising:
via the processor
acquiring an image including a subject;
detecting, in addition to a subject region representing the subject, at least a part of the subject as a magnification target from the image;
inserting, in a display screen on which the image is displayed, a magnification region in which a target region representing the magnification target is magnified, into the display screen; and
executing, in a case where an overlapping region in which the subject region and the magnification region overlap with each other is generated on the display screen and a condition is satisfied, overlapping degree reduction processing of reducing an overlapping degree of the overlapping region.

20. A non-transitory computer-readable storage medium storing an operation program of a display control device including a processor, the operation program causing the processor to execute a process of:
acquiring an image including a subject;
detecting, in addition to a subject region representing the subject, at least a part of the subject as a magnification target from the image;
inserting, in a display screen on which the image is displayed, a magnification region obtained by magnifying a target region representing the magnification target into the display screen; and
executing, in a case where an overlapping region in which the subject region and the magnification region overlap with each other is generated on the display screen and a condition is satisfied, overlapping degree reduction processing of reducing an overlapping degree of the overlapping region.
